(19) United States
(12) Patent Application Publication
(10) Pub. No.: US 2024/0185180 A1
(43) Pub. Date: Jun. 6, 2024

(54) DECENTRALIZED MANAGEMENT OF VEHICLE OWNERSHIP

(71) Applicant: Ford Global Technologies, LLC, Dearborn, MI (US)

(72) Inventors: Zoheb Mohammed, Farmington Hills, MI (US); Karl Nathan Clark, Belleville, MI (US); Riaz Ulla, Lasalle (CA); Vladimir Stefanovski, Windsor (CA)

(21) Appl. No.: 18/073,442

(22) Filed: Dec. 1, 2022

(51) Int. Cl. G06Q 10/10; G06Q 30/06; H04L 9/00

(52) U.S. Cl. CPC G06Q 10/10; G06Q 30/06; H04L 9/50; H04L 2209/84

(57) ABSTRACT

Methods and systems are provided for managing, tracking, and storing vehicle ownership data in a decentralized, distributed vehicle management system. In an embodiment, a decentralized, distributed vehicle management system comprises a blockchain; a streaming service configured to provide event data in real time to a contract executing virtual machine (VM) embedded in the blockchain; and a non-transitory memory storing instructions that when executed by a processor of the vehicle management system, cause the vehicle management system to manage ownership data of a vehicle of the vehicle management system, including changes in ownership of the vehicle, via smart contracts that execute automatically in response to real-time event data streamed by the streaming service, wherein the smart contracts are created by various users of the vehicle management system linked to or associated with the vehicle.

### FIELD

The present description relates to methods and systems for managing and tracking ownership of a vehicle, based on smart contracts stored in a distributed ledger such as a blockchain.

### BACKGROUND/SUMMARY

When a vehicle changes ownership, multiple stakeholders may be alerted to facilitate the transaction or revise their interaction/relationship with the buyer, seller, and/or vehicle after the transaction completes. Stakeholders may include buyers, sellers, a government agency, a lending institution, insurance agency, car company, and/or other service providers. As a result, transaction processing may be inefficient for managing loan payoffs, insurance cancelation, title transfer, registration, etc.

Various systems have been proposed for tracking and managing ownership of physical assets, with various degrees of automation. As an example U.S. patent application 20200151811A1, which discloses a platform for managing real and personal property, including sharing a history of ownership/changes to the real property with an online community and/or transferring the history to a new buyer after a sale. However, centralized systems such as this may not be secure. Records maintained by conventional techniques may be susceptible to tampering, unauthorized or inadvertent changes, or may be incomplete. Further, it may be difficult to ascertain the integrity and veracity of records maintained by parties which may have a vested interest in relation to the records being kept. Additionally, centralized systems may not present a robust solution for use in real time. If the system experiences unexpected downtime (e.g., due to a power outage, or a defect), or if the system becomes unexpectedly unavailable (e.g., due to network connectivity issues), no ownership data may be accessible to users of the system.

An alternative to such centralized systems is a decentralized ownership management system, based on a distributed ledger (e.g., a blockchain). In distributed ledger systems, one or more smart contracts may be used to enforce agreements between participants and/or perform one or more actions based on conditions established in the one or more smart contracts. For example, U.S. patent Ser. No. 10/755,327B2 discloses a blockchain-based vehicle record platform that stores historical information about vehicles, financing information, ownership and transaction information. U.S. patent 20210090189A1 teaches using blockchains to record, manage, and transfer ownership rights to land titles. U.S. Ser. No. 10/937,253B2 teaches a method for receiving vehicle sensory data, storing the data in a blockchain, performing validation of data based on standards, identifying actions and registered entities associated with the actions, and transmitting requests to the registered entities. U.S. Ser. No. 10/943,307B1 discloses systems and methods for interacting with smart contracts stored on a blockchain to control vehicle-related activity, including receiving one or more blockchain transactions associated with a particular vehicle and indicative of at least one of a trigger condition associated with the vehicle; writing the blockchain transactions to the blockchain accessible by a plurality of validation entities (stakeholders); and routing the blockchain transactions to respective smart contracts associated with the vehicle and/or automatically executing an indicated action of the smart contract in response to the particular trigger condition.

However, the inventors herein have identified various issues with current decentralized, distributed ledger systems for managing ownership data. The systems may narrowly focus on certain kinds of data or certain participants in a distributed ledger system, and may not be easily expandable to flexibly incorporate other participants. The systems may not allow participants to independently write their own smart contracts to perform customized actions not foreseen by the system. The actions accomplished via the smart contracts may include verifying data and sending notifications or requests, but may not facilitate transactions carried out independently between participants that do not involve a central managing application. The smart contracts may also not support more complex, multi-stage transactions or negotiations between parties in the system. For example, an ownership management system may store data of a buyer, a seller, and/or a sale of a vehicle, and send a notification of a purchase request to the seller, or an acceptance of the purchase request to the buyer. However, the ownership management system may not allow the buyer and the seller to establish their own smart contracts including customized conditions of purchase/sale. The ownership management system may not facilitate multiple interactions between the buyer and seller in which the customized conditions are negotiated, agreed upon, and confirmed without human intervention. The ownership management system may not support contract execution in a cascading or chained fashion, where a participant-written first smart contract may perform a first task, and may execute a second smart contract written by a different participant based on a result of the first task, which may execute a third smart contract of either of the two participants or of the ownership management system based on a result of the second task, and so on. The systems may not support, without human intervention, transferring one-time or regular payments between participants, for example, via digital wallets; managing receipts and confirmations; and updating the data in the blockchain. Additionally, the vehicle ownership data may not be stored in the blockchain in a manner that supports easy and efficient inclusion of additional data of a vehicle, vehicle owner, or other participant in the system without altering the programming code by which the system is operated and managed.

In one embodiment, the problems described above may be addressed by a decentralized, distributed vehicle management system comprising a blockchain; a streaming service configured to provide event data in real time to a contract executing virtual machine (VM) embedded in the blockchain; and a non-transitory memory storing instructions that when executed by a processor of the vehicle management system, cause the vehicle management system to manage ownership data of a vehicle of the vehicle management system, including changes in ownership of the vehicle, via smart contracts that execute automatically in response to real-time event data streamed by the streaming service, wherein the smart contracts may be created by various users of the vehicle management system linked to or associated with the vehicle, and executed at at least one of the contract executing VM of the blockchain and a contract executing VM of a copy of the blockchain installed on a computing device of a user of the various users. The various users of the vehicle management system may include, for example, a seller of the vehicle; a buyer of the vehicle; a lending institution providing financing for the vehicle; an insurance agency providing an insurance policy for the vehicle; a regulatory authority that oversees an operation of the vehicle; a government agency that issues a title of the vehicle; and/or other parties linked to or associated with the vehicle. The smart contracts may perform various interactions and transactions between various users of the vehicle management system, without being controlled by the vehicle management system. For example, the smart contracts may perform interactions and transactions between parties involved in a sale of the vehicle.

The smart contracts may be stored in a non-fungible token (NFT) of the vehicle, and/or one or more NFTs of users of the vehicle management system, where the NFTs are stored in the blockchain. Specifically, the NFTs may be stored in a master copy of the blockchain stored in the vehicle management system, and/or one or more copies of the blockchain, where each of the one or more copies of the blockchain are stored in a computing device of a user of the vehicle management system. Additionally, a copy of the streaming service may be installed on the computing devices of the users of the vehicle management system. Further, each copy of the blockchain may include a contract executing virtual machine (VM) configured to receive real-time event data from one or more of the streaming services.

In other words, a first computing device of a first user of the vehicle management system may include a first streaming service and a first copy of the blockchain, where the first copy of the blockchain includes a first contract executing VM and stored NFTs of vehicles and users of the vehicle management system. A second computing device of a second user of the vehicle management system may include a second streaming service and a second copy of the blockchain, where the second copy of the blockchain includes a second contract executing VM and the stored NFTs of vehicles and users of the vehicle management system. A third computing device of a third user of the vehicle management system may include a third streaming service and a third copy of the blockchain, where the third copy of the blockchain includes a third contract executing VM and the stored NFTs of vehicles and users of the vehicle management system.

The first computing device may stream a first set of real-time event data via the first streaming service. The second contract executing VM of the second computing device may receive the first set of real-time event data. The first set of real-time event data may reference the first user, the second user, and a vehicle. The second contract executing VM may retrieve NFTs of the first user, the second user, and the vehicle from the second copy of the blockchain stored at the second computing device. The second contract executing VM may retrieve one or more smart contracts stored in one or more of the NFTs, and execute the one or more smart contracts based on the first set of real-time event data. Executing the one or more smart contracts based on the first set of real-time event data may generate a result, which may be streamed from the second streaming service of the second computing device as a second set of real-time event data. The second set of real-time event data may be received by the third contract executing VM of the third computing device. The second set of real-time event data may reference the first user, the second user, and a vehicle. The third contract executing VM may retrieve the NFTs of the first user, the second user, and the vehicle from the third copy of the blockchain stored at the third computing device. The third contract executing VM may retrieve the one or more smart contracts stored in the one or more of the NFTs, and execute the one or more smart contracts based on the second set of real-time event data, and so on.

In this way, a same set of smart contracts may be executed at various computing devices of various users of the vehicle management system without any processing occurring at the vehicle management system. In one example, the first user may be a buyer of a vehicle, the second user may be a seller of the vehicle, and the third user may be a vehicle title-issuing government agency, and the set of smart contracts may be executed in a distributed or chained manner, between different computing devices, to perform transactions involved in a sale of the vehicle from the seller to the buyer. The transactions may include, for example, transferring funds of the buyer to the seller to pay the purchase price of the vehicle; requesting and receiving a title from a government agency; registering a license plate of the vehicle with a regulatory authority; updating an insurance policy of the buyer and cancelling an insurance policy of the seller; disassociating one or more digital keys of the seller to the vehicle; cancelling one or more smart contracts of the seller regarding the vehicle; and/or generating a digital key for the buyer, and sending the digital key to the buyer. The smart contracts may also change, replace, update, and/or store new data in relevant NFTs, and/or update the copies of the blockchain stored at the computing devices.

By managing the ownership data via the smart contracts, which may be generated and customized by various users of the vehicle management system (for example, via a user-friendly graphical user interface (GUI) of the vehicle management system), management of the vehicle ownership data may not rely on an availability of the vehicle management system or a quality of a wireless connection between a computing device and the vehicle management system, resulting in a more efficient, robust, and distributed functioning of the vehicle management system. Additionally, by storing the smart contracts in a distributed fashion across a plurality of copies of the blockchain, a validity of the smart contracts may be verified at any time by consulting the various copies, thereby increasing a security of the ownership data and decreasing a possibility of an unauthorized access to the ownership data.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic block diagram of an exemplary vehicle management system, according to an embodiment;

FIG. 2A is a schematic block diagram of a first non-fungible token (NFT) including data of a vehicle included in a vehicle management system, according to an embodiment;

FIG. 2B is a schematic block diagram of a second NFT including data of a person or entity included in a vehicle management system, according to an embodiment;

FIG. 3 is a flowchart that illustrates an exemplary method for managing vehicle data on a blockchain, according to an embodiment;

FIG. 4A is a flowchart that illustrates a first part of an exemplary method for managing a vehicle sale and a change of ownership without human intervention, and storing the data in a blockchain, according to an embodiment;

FIG. 4B is a flowchart that illustrates a second part of the method of 4A for managing a vehicle sale and a change of ownership without human intervention, and storing the data in a blockchain, according to an embodiment;

FIG. 5 is a flowchart that illustrates an exemplary method for executing a smart contract stored in an NFT in a blockchain to perform various transactions of a vehicle sale, according to an embodiment; and

FIG. 6 is a flowchart that illustrates an exemplary method for a vehicle for associating insurance or additional third-party data with the vehicle on the blockchain based on a smart contract, according to an embodiment.

### DETAILED DESCRIPTION

The following description relates to systems and methods for a decentralized vehicle management system for storing vehicle ownership data in a distributed ledger system, and automatically managing various transactions between different parties and/or entities involved in a sale, purchase, or other change of ownership of a vehicle. Automatically managing the various transactions between the different parties and/or entities may include, inter alia, managing requests for information and responses to the requests; managing one or more negotiation processes between a buyer and a seller of the vehicle; managing confirmation and validation of information exchanged between the parties; managing payments made between the parties using digital wallets; performing various notifications based on information received; and/or restricting operational control of the vehicle based on the received information. Unlike other ownership managements systems known in the art, the various communications, negotiations, and transactions may be performed without human intervention using smart contracts, which may be stored on the blockchain. As a result of performing the various communications, negotiations, and transactions automatically via the smart contracts, various procedures involved in an ownership change of a vehicle may be carried out without relying on human intervention, and carried out more rapidly and efficiently than when human intervention is relied on.

It should be appreciated that the word “transaction” as used herein refers to an exchange or data or funds between two parties involved in a change of ownership of a vehicle. This is in contrast with a “blockchain transaction”, which is standard terminology for writing data to a blockchain. To avoid misinterpretation, blockchain transactions are explicitly described as such herein.

A distributed ledger is a transactional record that is maintained at each node of a peer to peer (P2P) network. Commonly, the distributed ledger is comprised of groupings of blockchain transactions bundled together into a “block.” When a change to the distributed ledger is made (e.g., when a new blockchain transaction and/or block is created), each node must form a consensus as to how the change is integrated into the distributed ledger. Upon consensus, the agreed-upon change is pushed out to each node so that each node maintains an identical copy of the updated distributed ledger. Any change that does not achieve a consensus is ignored. Accordingly, unlike a traditional, centralized ledger, a single party cannot unilaterally alter the distributed ledger.

In one application of distributed ledgers, each new block may be cryptographically linked to the previous block in order to form a chain (e.g., a blockchain). More particularly, to create a new block, each blockchain transaction within a block may be assigned a hash value (e.g., an output of a cryptographic hash function, such as SHA-2 or MD5). These hash values may then be combined together utilizing cryptographic techniques (e.g., a Merkle Tree) to generate a hash value representative of the entire new block. This hash value may then be combined with the hash value of the previous block to form a hash value included in the header of the new block, thereby cryptographically linking the new block to the blockchain. To this end, the precise value utilized in the header of the new block is dependent on the hash value for each blockchain transaction in the new block, as well as the hash value for each blockchain transaction in every prior block.

According to some aspects, the hash value generated for the new block may be used as an input to a cryptographic puzzle that manipulates a nonce value. When a solution to the cryptographic puzzle is found, the solving node publishes the solution and the other nodes then verify that the solution is the correct solution. Because the solution may also depend on the particular hash values for each blockchain transaction within the blockchain, if the solving node attempted to modify any blockchain transaction, the solution would not be verified by the other nodes. More particularly, if a single node attempts to modify a prior blockchain transaction within the blockchain, a cascade of different hash values are generated for each tier of the cryptographic combination technique. This results in the header for one or more blocks being different than the corresponding header(s) in every other node that did not make the exact same modification. As a result, the solution generated by the modifying node would not solve the cryptographic puzzle presented to any node without the identical modification. Thus, the version of the new block generated by the modifying node is readily recognized as including an improper modification and is rejected by the consensus. This inability to modify past blockchain transactions lead to blockchains being generally described as trusted, secure, and/or immutable.

A smart contract is a computer protocol that enables the automatic execution and/or enforcement of an agreement or transaction between different parties. In particular, the smart contract may be computer code that is located at a particular address on the blockchain. The smart contract may include one or more trigger conditions, that, when satisfied, correspond to one or more actions. For some smart contracts, which action(s) of the one or more actions are performed is determined based upon one or more decision conditions. The contract executing VM executing the smart contract may subscribe to one or more data streams including data related to a trigger condition and/or a decision condition. Accordingly, the contract executing VM may route the data streams to the smart contract so that the smart contract may detect that a trigger condition has occurred and/or analyze a decision condition to direct the enforcement entity to perform one or more actions.

The smart contract may evaluate conditions, where one or more actions are taken if a condition or set of conditions are met, and if the condition or set of conditions are not met, the one or more actions are not taken and/or different actions are taken. The smart contracts may be executed by a contract executing VM embedded in a master copy of the blockchain stored at the vehicle management system, or a contract executing VM embedded in a copy of the blockchain held by a user of the vehicle management system.

The smart contracts may be automatically executed based on real-time event data received at the contract executing VM embedded in the blockchain. The real-time event data may be transmitted from a streaming service installed and running at a computer or computing device of any users of the vehicle management system with an interest the vehicle. Executing the smart contracts at the computer or computing device of a user rather than the vehicle management system may be advantageous for various reasons. Contracts may be executed more quickly at the at the computer or computing device of a user, where communication between a user and the vehicle management system may not be relied on. For example, the communication may be delayed or unavailable due to network or technical issues. A use of processing and memory resources by the vehicle management system may be reduced, increasing a general efficiency of the vehicle management system.

By recording ownership data in the distributed ledger, there is a public and trusted record of the smart contract and the reasoning behind any action performed as directed by the smart contract. As a result, parties that generate a smart contract may rely on an automatic enforcement of their contracts in a transparent and objective manner. The distributed ledger may either be a public ledger (each node may readily view the underlying data of each blockchain transaction) or a private ledger (the underlying data needs an encryption key to be viewed), or a combination of public and private ledger.

As described herein, steps involved in performing the various transactions involving the change of ownership of the vehicle may be defined in the one or more smart contracts. In various embodiments, the smart contracts are stored in the blockchain in one or more non-fungible tokens (NFTs). For example, a first NFT may be stored in the blockchain for the vehicle, which may include data of the vehicle and may include smart contracts pertaining to the vehicle. The smart contracts of the vehicle may be added to the NFT for the vehicle by the vehicle management system and may include, for example, generic smart contracts (e.g., that may apply to a plurality of vehicles) for managing typical operations involved in a sale of the vehicle. The generic smart contracts may include sub-contracts for paying a seller, registering the vehicle, associating an insurance policy with the vehicle, and the like. A second NFT for an owner of the vehicle may be stored in the blockchain, which may include data of the owner and may include smart contracts pertaining to the owner with respect to the vehicle. The smart contracts pertaining to the owner with respect to the vehicle may be added to the NFT by the owner, and may include, for example, custom smart contracts establishing terms and conditions of a sale of the vehicle to a prospective buyer. A third NFT for the prospective buyer of the vehicle may be stored in the blockchain, which may include data of the prospective buyer and may include smart contracts pertaining to the buyer with respect to the vehicle. The smart contracts pertaining to the buyer with respect to the vehicle may be added to the NFT by the buyer, and may include, for example, custom smart contracts establishing terms and conditions of the prospective buyer for purchasing the vehicle. It should be appreciated that the examples provided herein are for illustrative purposes and are not limitative. Additional NFTs may be stored on the blockchain for other entities or parties associated with or linked to the vehicle, such as a lending institution, a regulatory authority, an insurance agency, and the like.

By storing vehicle, owner, and other data of the vehicle in NFTs, where the NFT's further include smart contracts for carrying out various actions with respect to the vehicle, a functioning of the vehicle management system may be simplified and made more efficient. Rather than including, maintaining, and perpetually expanding a code base of the vehicle management system to handle increasingly complex transactions between parties to the distributed ledger, based on various complicated decision trees, handling of the transactions may be offloaded to the smart contracts, which may execute automatically when certain conditions are met. As described herein, the smart contracts may be flexibly added and removed in a decentralized and distributed fashion by the users of the vehicle management system, who are participants in the distributed ledger system. The flexible addition and removal may also be performed by various computing devices of the users in a distributed fashion, reducing a consumption of resources at the vehicle management system. As a result, the vehicle ownership management system may support more efficient scaling, faster growth, and more efficient management overall. Additionally, by managing change of ownership transactions using smart contracts that are independently created and stored on a blockchain, a greater flexibility in performing different transactions for different vehicles and/or users may be achieved. Further, the immutability of the blockchain provides a permanent record of the history of the ownership of the vehicle.

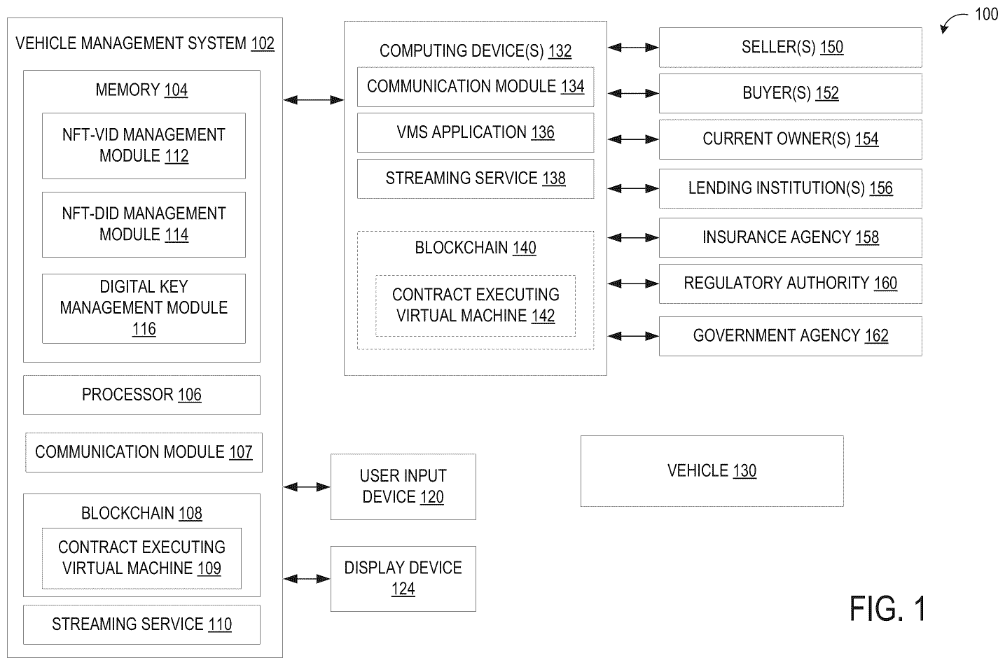

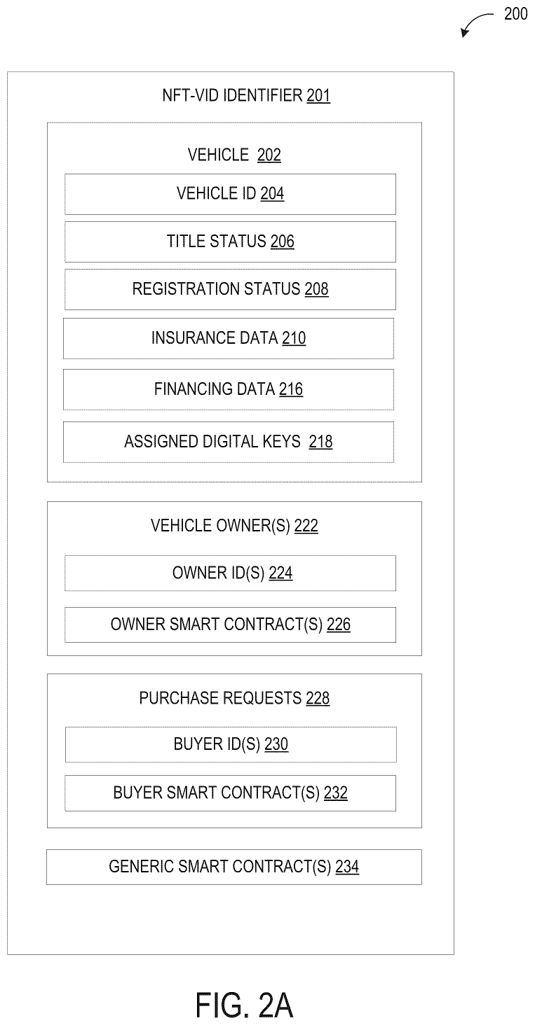

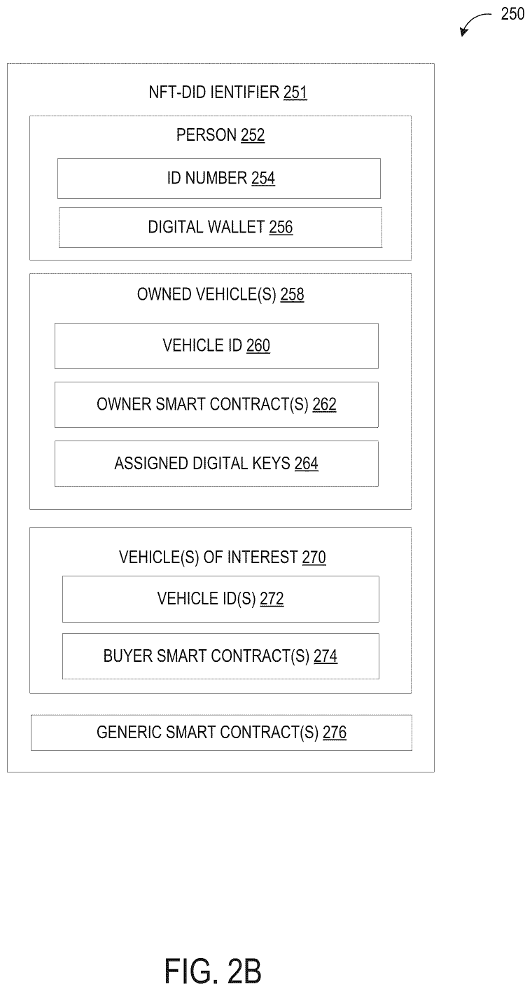

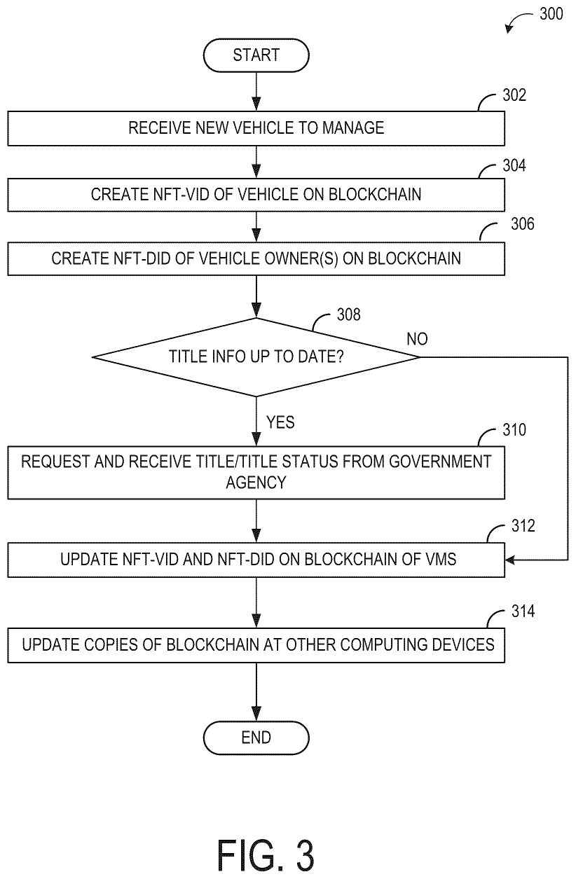

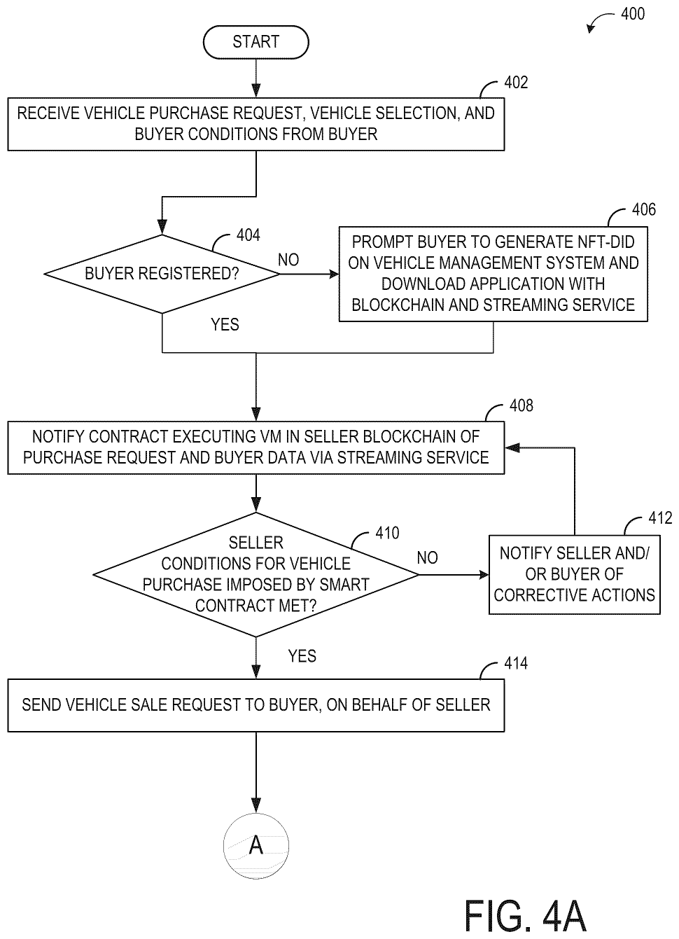

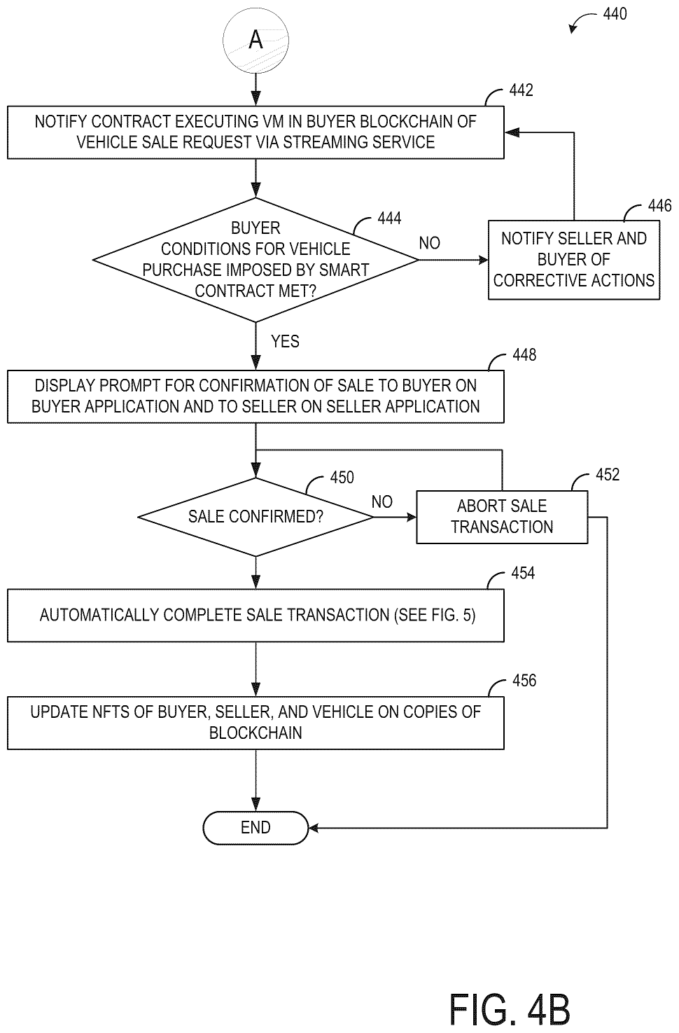

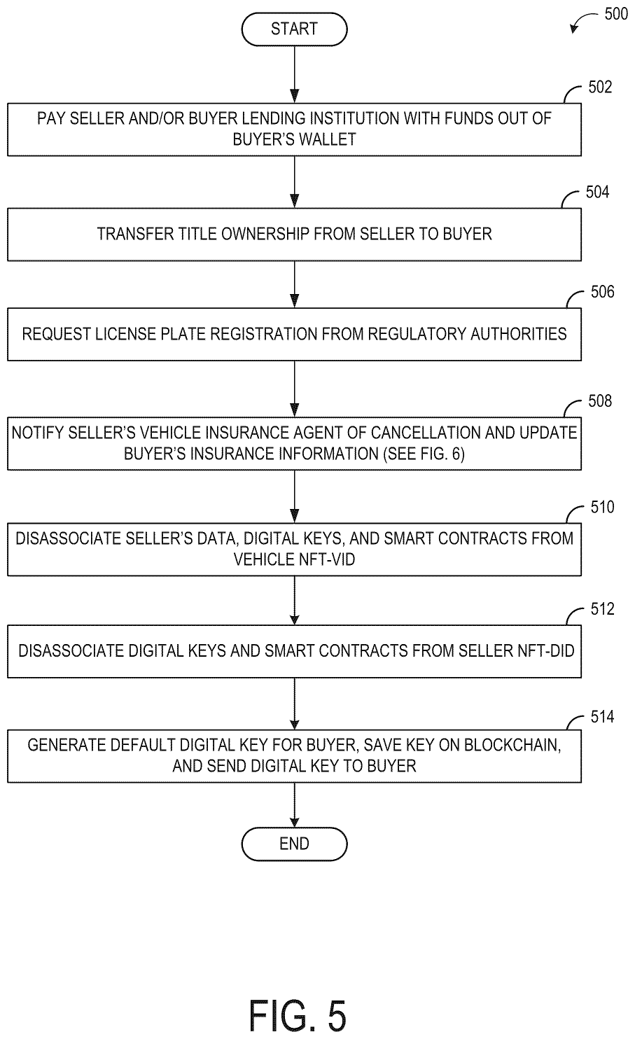

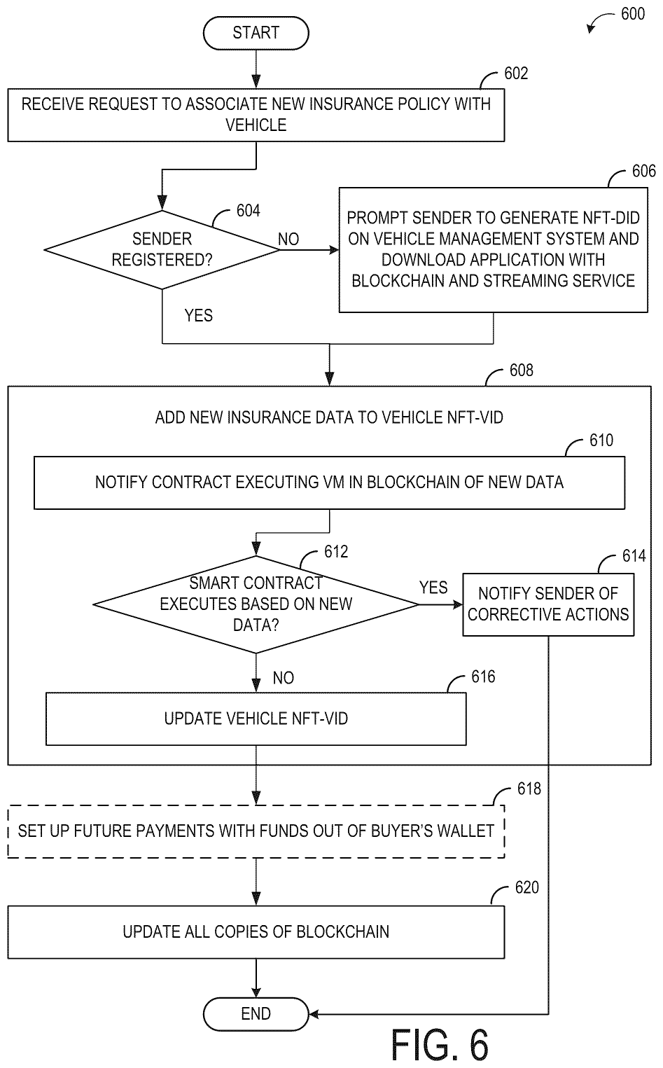

A vehicle management ecosystem such as that shown in FIG. 1 may include a vehicle management system in wireless communication with one or more computing devices held by users of the vehicle management system. The vehicle management system may store ownership data of a plurality of vehicles in a plurality of NFTs. The plurality of NFTs may include NFTs of vehicles, as shown in FIG. 2A, and NFTs of entities participating in the vehicle ownership ecosystem, as shown in FIG. 2B. New vehicles may be added to the vehicle management system by following one or more steps of a method shown in FIG. 3. When a vehicle of the plurality of vehicles is sold, the sale may be managed via one or more smart contracts by following the method of FIGS. 4A and 4B. Various transactions involved in changing an ownership of the vehicle, including financial transactions, may be performed without human intervention by following a method described in FIG. 5. Additional data, such as an insurance policy, may be associated with the vehicle in one or more NFTs by following one or more steps of a method shown in FIG. 6.

FIG. 1 shows a vehicle ownership ecosystem 100, including a vehicle management system 102. Vehicle management system 102 may be used to manage ownership data and/or perform transactions involved in a change of ownership of a vehicle 130. The transactions may involve any of the users of vehicle management system 102, as described in greater detail below. Vehicle 130 may be a car, a bus, a truck, or a different type of machinery or vehicle operated by an operator. Vehicle 130 may be powered by an internal combustion engine, or vehicle 130 may be an electric vehicle powered by an electrical power source, or vehicle 130 may be a hybrid vehicle powered by both an internal combustion engine and an electrical power source. Vehicle 130 may also be a specialized vehicle used in a specific environment, such as, for example, a golf cart or transportation vehicle used in certain areas of a private facility such as an indoor facility. Vehicle 130 may be operated on public and/or private roads and highways, or on a set of tracks or rails (e.g., a train). In general, vehicle 130 may be any type of vehicle operated by an operator.

Vehicle management system 102 includes one or more processors 106 configured to execute machine readable instructions stored in non-transitory memory 104. Memory 104 may include one or more data storage structures, such as optical memory devices, magnetic memory devices, or solid-state memory devices, for storing programs and routines executed by processor(s) 106 to carry out various functionalities disclosed herein. Memory 104 may include any desired type of volatile and/or non-volatile memory such as, for example, static random access memory (SRAM), dynamic random access memory (DRAM), flash memory, read-only memory (ROM), etc.

Processor(s) 106 may be any suitable processor, processing unit, or microprocessor, for example. Processor(s) 106 may be a multi-processor system, and, thus, may include one or more additional processors that are identical or similar to each other and that are communicatively coupled via an interconnection bus. Processor(s) 106 may be single core or multi-core, and the programs executed thereon may be configured for parallel or distributed processing. In some embodiments, processor(s) 106 may optionally include individual components that are distributed throughout two or more devices, which may be remotely located and/or configured for coordinated processing. In some embodiments, one or more aspects of processor(s) 106 may be virtualized and executed by remotely-accessible networked computing devices configured in a cloud computing configuration.

Vehicle management system 102 may include a communication module 107, which may manage wireless communication between vehicle management system 102 and one or more computing devices 132, which may include a communication module 134 for such purpose. Communication modules 107 and 134 may be configured to communicate with other communication modules of other computing devices via various communication networks, for example, via wireless communication or data transmission over one or more radio links or digital communication channels, using any standard or technology (e.g., GSM, CDMA, TDMA, WCDMA, LTE, EDGE, OFDM, GPRS, EV-DO, UWB, e.g., 802 including Ethernet, WiMAX, and/or others). In some embodiments, the communication networks may include a mesh or ad hoc network wherein various computing devices function as nodes of the mesh or ad hoc network.

The one or more computing devices 132 may be owned and/or operated by one or more respective parties with an ownership interest in vehicle 130, or individuals and/or parties involved in transactions regarding vehicle 130 with respect to a change of ownership. The one or more respective parties may include, for example, one or more sellers 150 of vehicle 130, at a time of a sale of vehicle 130; one or more buyers 152 of vehicle 130, at the time of a sale of vehicle 130; one or more current owners 154 of vehicle 130, which may include a buyer of the one or more buyers 152 or a seller of the one or more sellers 150; one or more lending institutions 156 providing financing for vehicle 130; one or more insurance agencies 158 providing insurance for vehicle 130; and one or more regulatory authorities 160 with whom vehicle 130 is registered; and/or a government agency 162 that may issue a title for vehicle 130. For example, the one or more regulatory authorities 160 may include a department of motor vehicles (DMV) of a state in which vehicle 130 is registered, and the government agency 162 may be the secretary of state of the state. It should be appreciated that the examples provided herein are for illustrative purposes, and in other embodiments, the one or more respective parties may include other types of parties linked to or associated with vehicle 130.

Vehicle management system 102 may include a blockchain 108, which may be used by vehicle management system 102 as a distributed ledger to store ownership data of vehicle 130. In various embodiments, blockchain 108 may store one or more non-fungible tokens (NFTs) associated with and identifying vehicle 130, referred to herein as NFT-VIDs. Blockchain 108 may also store one or more NFTs associated with and identifying the various parties linked to or associated with vehicle 130 described above (e.g., sellers, buyers, owners, lending institutions, insurance agencies, regulatory authorities, etc.), referred to herein as NFT-DIDs. The NFT-VID and the NFT-DIDs may be written to blockchain 108 and updated as new blocks are added to blockchain 108.

Blockchain 108 may include a contract executing virtual machine (VM) 109 that may execute one or more smart contracts included in an NFT-VID or an NFT-DID, as described above. Vehicle management system 102 may include a streaming service 110, which may stream real-time event data to the contract executing VM. The real-time event data may include data on actions performed with respect to vehicle 130. For example, the real-time event data may include a purchase request made by a prospective buyer of vehicle 130; a response made by an owner of vehicle 130; a change in a status of a title or registration of vehicle 130; a monthly payment to a lending institution for vehicle 130 being due; an access made to vehicle 130 by an owner or operator of vehicle 130, and so on. The real-time event data may also include a current time and date, and/or other information not immediately related to vehicle 130 but relevant to a processing of one or more smart contracts of vehicle 130. In some embodiments, when a smart contract is written for vehicle 130 and stored in the blockchain, information that may be relied upon by the smart contract for execution may be requested or scheduled to be streamed by the streaming service 110. The contract executing VM may execute one or more smart contracts relating to the operator and/or the vehicle based on the received event data, as described in greater detail below in reference to FIGS. 3-7. Contract executing VM 109 may also receive real-time event data streamed from one or more streaming services 138 of corresponding computing devices 132. Contract executing VM 109 may execute the one or more smart contracts based on the real-time event data received from streaming services 138.

In some embodiments, a blockchain 140 may be included in one or more computing devices 132, where blockchain 140 is a copy of blockchain 108. In such embodiments, a contract executing VM 142 of blockchain 140 may be configured to receive the real time data from streaming service 138, and execute the one or more smart contracts stored on blockchain 140 based on the real time data. By including blockchain 140 in the one or more computing devices 132, a communication with vehicle management system 102 is not relied on for smart contract execution, whereby a lack of availability of vehicle management system 102 (e.g., due to unexpected downtime, or a lack of connectivity with the one or more computing devices 132) may not affect the execution of the one or more smart contracts.

Further, by including copies of blockchain 108 at the one or more computing devices 132, a distributed ledger may be created, where a validity of data stored on the blockchain (e.g., including various NFT-VIDs, various NFT-DIDs, and/or the smart contracts included in either) may be verified by consulting a plurality of copies of blockchain 108 at various computing devices 132, thus increasing a security of blockchain 108. Additionally, a robustness of vehicle management system 102 to external factors may be increased. For example, in a first condition where execution of the smart contracts is performed at blockchain 108 of vehicle management system 102, a power outage may make vehicle management system 102 unavailable to a computing device 132, whereby the computing device 132 may not be able to execute the smart contracts. In a second condition where execution of the smart contracts is performed at blockchain 140 of the computing device 132, execution of the smart contracts stored on blockchain 140 may not be affected by the power outage.

Non-transitory memory 104 of vehicle management system 102 may include an NFT-VID management module 112, which may which may comprise instructions for managing the NFT-VIDs that are stored on blockchain 108. Similarly, non-transitory memory 104 may include an NFT-DID management module 114, which may which may comprise instructions for managing the NFT-DIDs that are stored on blockchain 108. Specifically, NFT-VID management module 112 and NFT-DID management module 114 may include instructions that, when executed by processor(s) 106, cause vehicle management system 102 to conduct one or more of the steps of method 400 for creating, storing, and updating the NFT-VIDs and NFT-DIDs, respectively, discussed in more detail below in reference to FIG. 3.

In some embodiments, vehicle management system 102 may additionally include a digital key management module 116, which may comprise instructions for managing digital keys stored in the NFT-VIDs and/or NFT-DIDs on blockchain 108 and/or blockchain 140.

Vehicle management system 102 may be operably/communicatively coupled to a user input device 120 and a display device 124. User input device 120 may comprise one or more of a touchscreen, a keyboard, a mouse, a trackpad, a motion sensing camera, or other device configured to enable a user to interact with and manipulate data within vehicle management system 102. In one example, user input device 120 may enable a user to perform various actions with respect to recording a purchase/sale or new owner of vehicle 130 on blockchain 108. For example, a seller may create one or more smart contracts (e.g., owner smart contracts 262) imposing sale conditions to be satisfied by a prospective buyer. A seller may also create one or more smart contracts (e.g., buyer smart contracts 274) imposing purchasing conditions to be satisfied by a prospective seller.

Display device 124 may include one or more display devices utilizing virtually any type of technology. In some embodiments, display device 124 may comprise a computer monitor on which data of vehicle management system 102 may be displayed. The data of vehicle management system 102 may include, for example, data of a vehicle 130 (e.g., vehicle ID, title status, registration status, etc.); one or more vehicle owner(s) 222 or parties who are buyers or sellers of vehicle 130; one or more purchase requests 228 from a prospective buyer; one or more vehicles of interest 270 sought by the prospective buyer; or other data of users of vehicle management system 102. Display device 124 may be combined with processor(s) 106, non-transitory memory 104, and/or user input device 120 in a shared enclosure, or may be peripheral display devices and may comprise a monitor, touchscreen, projector, or other display device known in the art, which may enable a user to and/or interact with various data stored in non-transitory memory 104.

Turning now to FIG. 2A, an exemplary NFT-VID 200 is shown, which may be stored on a blockchain of a vehicle management system (e.g., vehicle management system 102), or a copy of the blockchain stored at a computing device (e.g., computing device 132) of a user of the vehicle management system and/or participant in a vehicle ownership ecosystem such as vehicle ownership ecosystem 100 of FIG. 1. NFT-VID 200 may include an NFT-VID identifier 201, which may be used to reference NFT-VID 200. NFT-VID 200 may include various modifiable and/or immutable data fields. In some embodiments, the various modifiable and/or immutable data fields may include both historical data and current data. The data fields may include a vehicle field 202, which may include immutable identifying information of a vehicle (e.g., a vehicle 130) to which NFT-VID 200 corresponds. In various embodiments, a single NFT-VID 200 may correspond to a single vehicle in a 1:1 relationship, where no other NFT-VIDs correspond to the vehicle and no other vehicles correspond to NFT-VID 200. Vehicle field 202 may include, for example, a vehicle ID 204, such as a Vehicle Identification Number (VIN). Vehicle field 202 may also include other immutable data fields for additional identifying information of the vehicle, such as make, model, color, year, etc., which to save space are not shown in FIG. 2A. The identifying information may include text data, and/or other types of data such as image data (e.g., one or more images of the vehicle, images of identifying data of the vehicle, etc.). In other embodiments, vehicle field 202 may include other modifiable data fields, for example, such as a title status field 206; a registration status field 208; an insurance data field including, for example, an insurance agent, policy number etc.; a financing data field 216 including, for example, a lending institution, outstanding loan information, etc., and so on.

Vehicle field 202 may include a modifiable assigned digital keys field 218, which may include information regarding one or more digital keys associated with vehicle 202. For example, a first digital key of the one or more digital keys may be assigned to a first owner of vehicle owners 222. The first digital key may establish that the first owner has access to all functionalities of vehicle 202 at all times. A second digital key of the one or more digital keys may be assigned to a first operator of vehicle 202. The second digital key may establish that the first operator has access to vehicle 202 at all times, and has access to a first set of functionalities of vehicle 202. A third digital key of the one or more digital keys may be assigned to a second operator of vehicle 202. The third digital key may establish that the second operator has access to vehicle 202 at all times, and has access to a second set of functionalities of vehicle 202, and so on. Over time, various digital keys may be created and revoked, which may be tracked via assigned digital keys field 218.

The modifiable data fields of NFT-VID 200 may include a vehicle owner(s) field 222, which may store identifying information of one or more owners of the vehicle. The identifying information may include one or more owner IDs 224 (e.g., an owner ID 224 for each vehicle owner). For example, a first owner ID 224 of a previous owner or seller of the vehicle may be included, and a second owner ID 224 of a current owner or buyer of the vehicle may be included. In some embodiments, an owner ID 224 may be a driver's license of a respective vehicle owner 222, or a different type of identification. In other embodiments, the owner ID 224 may reference an NFT-DID of an owner of vehicle 202, for example, via an identifier of the NFT-DID, rather referencing the owner directly. The referenced NFT-DID may include owner identifying information, as described below in reference to FIG. 2B.

Additionally, vehicle owner(s) field 222 may include one or more smart contracts 226 that may be automatically executed when certain conditions are met. The one or more smart contracts 226 may be stored as computer code to be executed on a contract executing virtual machine (VM) embedded in a blockchain, such as blockchain 108 of FIG. 1, in response to the certain conditions being met, based on real-time event data made available to the contract executing VM. In various embodiments, the real-time event data may be streamed to the contract executing VM from a streaming service, for example, running at a computing device (e.g., computing device 132) of a user of a vehicle management system, such as vehicle management system 102 of FIG. 1. The execution of smart contracts is described in greater detail below in reference to FIGS. 3-6.

The modifiable data fields of NFT-VID 200 may include a purchase request(s) field 228, which may store information regarding bids by one or more prospective buyers of vehicle 202. The information may include one or more buyer IDs 230 (e.g., a buyer ID 230 for each purchase request). A buyer ID 230 may be a driver's license or other identification number or code of the prospective buyer, or a buyer ID 230 may reference an NFT-DID of the buyer, where the NFT-DID of the buyer may include identifying information of the buyer. Purchase request(s) field 228 may also include a smart contract(s) field 232, which may store one or more buyer smart contracts that may be automatically executed when certain conditions involved in or affecting an ownership of vehicle 202 are met.

For example, a buyer smart contract 232 of a respective buyer 230 may establish one or more conditions for purchasing vehicle 202, where a purchase of vehicle 202 is contingent on the one or more conditions being satisfied. When a purchase request 228 is sent from the buyer to the seller, a smart contract written by the seller (e.g., and stored in owner smart contracts 226) may determine whether the seller's conditions of sale are met. When the seller of vehicle 202 responds to a purchase request 228, a streaming service running at a computing device (e.g., computing device 132) of the seller may notify the contract executing VM embedded in a blockchain installed at the vehicle management system, or at a computing device of the buyer, or on a different computing device, of a sale offer. The contract executing VM may receive the sale offer. The contract executing VM may retrieve the buyer smart contract 232 from the NFT-DID of the buyer. The contract executing VM may submit the sale offer to the buyer smart contract 232 to determine whether the sale offer satisfies the one or more conditions of the buyer. If the sale offer does not satisfy the one or more conditions of the buyer, the smart contract may execute, and a corresponding notification may automatically be sent to either or both of the buyer and the seller to initiate a negotiation.

The negotiation may be performed via various stages of a multi-stage process. For example, a first purchase request of a buyer may not meet a first set of conditions of the seller, and the buyer and seller may be notified. The buyer may submit a second purchase request that proposes a second set of conditions of the buyer. The conditions of the buyer and the conditions of the seller may be received, edited, and re-submitted various times during the negotiation process to achieve a consensus between the buyer and the seller, where no human intervention is relied on during cach stage of the negotiation process (e.g., other than the intervention of the selling parties). Upon completing the negotiation and confirming the sale, the charge of ownership may be automatically carried out and recorded in the relevant NFTs of the vehicle management system.

By automatically sending the corresponding notification, no human intervention or centralized processing of the vehicle management system may be relied on to manage the negotiation. As a result, the decentralized negotiation may be carried out faster than if human intervention were relied on, at a lower cost, and may reduce a use of resources of the vehicle management system. In addition, the decentralized negotiation may be carried out in a more technologically robust manner, where a communication with the vehicle management system is not relied on to perform sale transactions between different users of the vehicle management system.

The modifiable data fields of NFT-VID 200 may include a generic smart contract(s) field 234, which may include one or more generic smart contracts (e.g., contracts not specific to vehicle 202 that may be used by a plurality of vehicles. The generic smart contracts may include contracts for managing transactions typically included in managing ownership of vehicles, such as contracts for exchanging funds between a buyer and a seller; registering a vehicle with a government agency and/or regulatory authority, associating insurance data with the vehicle, and so on.

FIG. 2B shows an exemplary NFT-DID 250 is shown, which may also be stored on a blockchain of a vehicle management system or a copy of the blockchain stored at a computing device of a user of the vehicle management system and/or users of a vehicle management system such as vehicle management system 102. NFT-DID 250 may include an NFT-DID identifier 251, which may be used to reference NFT-DID 250. NFT-DID 250 may include various modifiable and/or immutable data fields. The immutable data fields may include a person field 252, which may include identifying information of a person to which NFT-DID 250 corresponds. The person may be an owner of a vehicle, or a person linked to a vehicle in a different way. For example, the person may be a seller of a vehicle (e.g., seller(s) 150), a buyer of a vehicle (e.g., buyer(s) 152), an owner of a vehicle (e.g., owner(s) 154), a lending institution providing financing of a vehicle (e.g., lending institution(s) 156), an insurance agency insuring a vehicle (e.g., insurance agency 158), a regulatory authority with which a vehicle is registered and regulated (e.g., regulatory authority 160), a title-issuing government agency (e.g., government agency 162), or a different person or entity. In various embodiments, a single NFT-DID 250 may correspond to a single person in a 1:1 relationship, where no other NFT-DIDs correspond to the person and no other persons correspond to NFT-DID 250. Person field 252 may include identifying information of the person, such as, for example, an ID number 254 of the person (e.g., a driver's license). Person field 252 may also include other identifying information of the person (e.g., sex, age, certifications, qualifications, training data, etc.). The identifying information may include text data, and/or other types of data such as image data (e.g., an image of the person).

Person field 252 may include a modifiable digital wallet field 256, which may include an amount of currency of person 252 that may be applied to one or more transactions involving ownership of a vehicle. For example, the currency may be applied to purchase the vehicle from a seller; to purchase an insurance policy for the vehicle; to register the vehicle with relevant regulatory authorities; to pay a lending institution financing the purchase of the vehicle; and so on.

The modifiable data fields of NFT-DID 250 may include an owned vehicle(s) field 258, which may store identifying information of one or more vehicles (e.g., vehicles 202 of FIG. 2A) owned by person 252. The identifying information may include one or more vehicle IDs 260 (e.g., one vehicle IDs 260 for each vehicle owned). For example, a vehicle ID 260 may be a VIN number. In some embodiments, a vehicle ID 260 may reference an NFT-VID of an owned vehicle, for example, via an identifier of the NFT-VID, rather referencing the vehicle directly via a vehicle ID (e.g., VIN number). The referenced NFT-VID may include vehicle information, as described above in reference to FIG. 2A. Because the referenced NFT-VID may include vehicle information, owned vehicle(s) field 258 may include some vehicle data but not other vehicle data, which may be accessed via the referenced NFT-VID.

Owned vehicle(s) field 258 may include, for one or more owned vehicles 258, one or more modifiable owner smart contracts 262 that may be automatically executed when certain conditions of person 252 are met with respect to a corresponding owned vehicle 258. The one or more smart contracts 262 may be stored as computer code, which may be executed on a virtual machine embedded in a blockchain such as blockchain 108 of FIG. 1, in response to the certain conditions being met. In various embodiments, the one or more owner smart contracts 262 may include conditions that person 252 wishes to be satisfied to sell an owned vehicle 258 (e.g., seller conditions).

In some embodiments, owner smart contracts 262 may be identical to owner smart contracts 226 of NFT-VID 200 of FIG. 2A. In such cases, a first copy of a smart contract 262 created by a person 252 with reference to a vehicle 202 may be stored in owner smart contract(s) 262 of NFT-DID 250, and a second copy of the smart contract may be stored in owner smart contract(s) 226 of NFT-VID 200. Alternatively, references to one or more owner smart contract(s) 262 of NFT-DID 250 may be stored in owner smart contract(s) 226 (e.g., rather than storing two copies of the smart contract), or references to one or more owner smart contract(s) 226 of NFT-VID 200 may be stored in owner smart contract(s) 262 of NFT-DID 250.

Owned vehicle(s) 258 may additionally include an assigned digital keys field 264, which may include information on one or more digital keys for person 252 associated with one or more owned vehicles 258, as described above in reference to FIG. 2A.

The modifiable data fields of NFT-DID 250 may include a vehicles-of-interest field 270, which may store identifying information of one or more vehicles that person 252 may be interested in purchasing. The identifying information may include one or more vehicle IDs 272 (e.g., one vehicle ID 272 for each vehicle of interest 270). A vehicle ID 272 may be a VIN number or other identification number or code of a respective vehicle 202 (e.g., of FIG. 2A) owned by a different owner selling the vehicle (e.g., a seller), or vehicle ID 272 may reference an NFT-VID 200 of a vehicle 202 of the seller, where the NFT-VID 200 may include identifying information of the vehicle 202 (e.g., vehicle ID 204). Vehicles-of-interest field 270 may also include a buyer smart contract(s) field 274, which may store one or more smart contracts that may be automatically executed when certain conditions of person 252 and vehicle of interest 270 are met. In various embodiments, the one or more buyer smart contracts 262 may include conditions that person 252 wishes to be satisfied to purchase vehicle of interest 270 from a seller (e.g., buyer conditions).

The modifiable data fields of NFT-VID 250 may include a generic smart contract(s) field 276, which may include the one or more generic smart contracts not specific to vehicle 202 described above in reference to FIG. 2A. The generic smart contracts may include contracts for managing transactions typically included in managing ownership of vehicles, such as contracts for exchanging funds between a buyer and a seller; registering a vehicle with a government agency and/or regulatory authority, associating insurance data with the vehicle, and so on.

FIG. 3 shows an exemplary method 300 for managing and storing ownership and sale transaction data of a vehicle on a blockchain installed in a vehicle management system, such as vehicle management system 102 of FIG. 1. Method 300 may be executed by a processor of the vehicle management system, (e.g., processor 106), based on instructions stored in a memory (e.g., memory 104) of the vehicle management system. For example, the instructions may be stored in an NFT-VID management module (e.g. NFT-VID management module 112) of the memory, or in an NFT-DID management module (e.g. NFT-DID management module 114) of the memory. It should be appreciated that while management and storage of data pertaining to a vehicle is described herein, method 300 and the other methods disclosed herein may also apply to other types of physical assets. For example, method 300 may be used to track ownership, title status, payment information, etc. of real property, such as an apartment or rental home, or a different type of physical asset where purchase/sale transactions and interactions occur between various parties with respect to the physical asset, without departing from the scope of this disclosure.

Method 300 begins at 302, where method 300 includes receiving a new vehicle to manage. The new vehicle may be a recently manufactured vehicle owned by a dealership, where the dealership wishes to sell the new vehicle. Alternatively, the new vehicle may be a vehicle purchased by an owner affiliated with the vehicle management system, from a previous owner not affiliated with the vehicle management system.

At 304, method 300 includes creating an NFT-VID of the vehicle on a blockchain of the vehicle management system (e.g., blockchain 108). The NFT-VID may include at least identifying information of the vehicle and identifying information of one or more owners of the vehicle. If the vehicle is a recently manufactured vehicle, the NFT-VID may not include registration data, insurance data, financing data, and/or other data typically stored in the NFT-VID. The blockchain may be stored at the vehicle management system (e.g., blockchain 108 of FIG. 1). In some embodiments, the vehicle management system may receive the identifying information of the vehicle and identifying information of the owner(s) from the owner(s) via a user input device and a graphical user interface (GUI) displayed on a display device of the vehicle management system (e.g., user input device 120 and display device 124, respectively). For example, the GUI may be displayed in a website or web application of the vehicle management system. In other embodiments, the vehicle management system may receive the identifying information of the vehicle and identifying information of the owner(s) from a GUI of the VMS application installed at the computing device (e.g., VMS application 136).

At 306, method 300 includes creating an NFT-DID for each vehicle owner of one or more vehicle owners for which an NFT-DID has not been created. The NFT-DID may include at least identifying information of the respective vehicle owner and identifying information of the vehicle. The blockchain may be stored at the vehicle management system (e.g., blockchain 108 of FIG. 1). The vehicle management system may receive the identifying information of the respective vehicle owner the vehicle via the user input device and GUI of the vehicle management system, or from a GUI of the VMS application installed at the computing device, as described above in reference to step 304. The respective vehicle owner may also add money to a digital wallet (e.g., digital wallet 256) of the NFT-DID, which may be used to pay for transactions, for example, involving a sale of the vehicle.

At 308, method 300 includes determining whether the vehicle has a title associated with it that is up to date. Determining whether the vehicle has an up-to-date title associated with it may include consulting title status information of the vehicle stored in the NFT-VID of the vehicle (e.g., in title status field 206) (e.g., when the title and title status are provided by the owner during creation of the NFT-VID). In various embodiments, consulting the title status information of the vehicle stored in the NFT-VID may be performed by a smart contract stored in the NFT-VID of the vehicle or the NFT-DID of the owner. The smart contract may be a generic smart contract for checking title information of the vehicle, where the generic smart contract is automatically copied into either or both of the NFT-VID and the NFT-DID at a time of creation. The blockchain storing the NFTs may include a contract executing VM (e.g., contract executing VM 109 or 142). In an embodiment, the vehicle management system may execute instructions to determine whether the vehicle has an up-to-date title. If the vehicle does not have an up-to-date title, the vehicle management system may notify the contract executing VM, for example, via a streaming service (e.g., streaming service 110) running on the vehicle management system. The contract executing VM receive the streamed notification, and as a result of the notification, may execute the generic smart contract. The generic smart contract may output instructions (e.g., code) to be executed by the vehicle management system to request a title and/or a current status of the title from a government agency.

If at 308 it is determined that the vehicle has a title associated with it that is up to date, method 300 proceeds to 312. At 312, the NFT-VID and the NFT-DID may be saved to and/or updated on the blockchain.

Alternatively, if at 308 it is determined that the vehicle has no title associated with it, or title information that is out of date, method 300 proceeds to 310. At 310, method 300 includes requesting and receiving a title of the vehicle or a title status of an existing title from a government agency (e.g., government agency 162). The request may be sent and a response from the government agency including the title or title status information may be received, for example, via a communication module of the vehicle management system (e.g., communication module 107). Fees associated with generating a new title or accessing title data may be paid automatically by the smart contract, using money added to the digital wallet of the respective NFT-DID.

At 312, method 300 includes updating the NFT-VID of the vehicle and the NFT-DID of the respective owner on the blockchain, and at 314, method 300 includes updating all additional copies of the blockchain at other computing devices of the vehicle management system.

For example, the owner(s) may be a dealership selling the vehicle. The dealership may wish to include the vehicle in the vehicle management system, for example, to take advantage of the distributed and decentralized management of vehicle data within the vehicle management system, which may allow for a timely automated performance of various transactions involved in selling the vehicle. The dealership may download a vehicle management system (VMS) computer application (e.g., VMS application 136) to a computing device of the dealership (e.g., computing device 132). When the VMS application is installed on the computing device, the VMS application may establish communication between the computing device and a communication module of the vehicle management system (e.g., via communication module 107). The VMS application may download and install a copy of the blockchain of the vehicle management system (e.g., blockchain 140) on the computing device. The VMS application may download and launch a streaming service such as streaming service 138 on the computing device. In some embodiments, the streaming service may stream real-time event data from the computing device to a contract executing VM of the blockchain on the vehicle management system (e.g., contract executing VM 109). In other embodiments, the streaming service may stream the real-time event data to a contract executing VM of the copy of the blockchain on the computing device (e.g., contract executing VM 142), or both of the contract executing VMs 109 and 142 may receive the real-time event data streamed by the streaming service.

Once the VMS application, the, blockchain, and the streaming service are installed at the computing device of the dealership, the dealership may create an NFT-DID for the dealership, as described above. When the NFT-DID for the dealership is created, a generic smart contract for checking title status data with the government agency may be copied into the NFT-DID by the vehicle management system. The generic smart contract may automatically execute, whereby the generic smart contract may check a title status field of the NFT-VID to determine whether the title status is correct. If the title status in the title status field of the NFT-VID is not correct, the generic smart contract may automatically generate the request for title and/or title data from the government agency. The request for the title and/or title data may be handled by the government agency. In some embodiments, the request for the title and/or title data may be handled via one or more smart contracts written by the government agency and stored in an NFT-DID of the government agency on the blockchain. In other embodiments, the request for the title and/or title data may be handled by a separate application of the government agency, and a response may be streamed by a streaming service of the government agency back to the contract executing VM. In some cases, more than one interaction with the government agency may be made to obtain the title and/or the title data.

For example, the government agency may send a first response not including the title and/or title data. For example, the government agency may discover conflicting information in records of the government agency, and the government agency may request a clarification from the vehicle management system. The request for clarification may be sent in the first response. When the first response is received by the vehicle management system, the vehicle management system may verify the information of the vehicle, and send the verified information back to the government agency. The government agency may receive the verified information, and based on the verified information, the government agency may respond to the vehicle management system with the requested title and/or title data. When the requested title and/or title data are received back from the government agency, the title and/or title data may be updated in the NFT-VID of the vehicle.

In various embodiments, the actions taken to verify the information of the vehicle at the vehicle management system may be performed automatically by one or more smart contracts, and not by operational code of the vehicle management system. In some embodiments, the government agency may communicate back and forth with a first contract executing VM initiating the request for the title and/or title data, and a smart contract of the first contract executing VM may perform the verification. In other embodiments, the government agency may communicate with the vehicle management system (e.g., via communication module 107), and the vehicle management system may stream data of the communication to a second contract executing VM via the streaming service. The second contract executing VM may be the same as the first contract executing VM, or the second contract executing VM may be the same as the first contract executing VM (e.g., either or both of the first contract executing VM and the second contract executing VM may be on either of the vehicle management system or a different computing device). When the second contract executing VM receives the data, the second executing VM may execute the one or more smart contracts to perform the actions to verify the information of the vehicle. The result of the one or more smart contracts may be passed back to the original smart contract responsible for making the initial request for the title and/or title information, or to a different smart contract, which may formulate the response to the government agency. In some embodiments, the result of the one or more smart contracts verifying the information of the vehicle may be streamed by the streaming service, whereby the result may be accessible to the smart contract responsible for making the initial request, or the different smart contract. In this way, the title and/or title information may be obtained via the vehicle management system rather than directly interacting with the government agency using human interaction, which may result in the transaction may be carried out automatically and more efficiently.

Additionally, one or more smart contracts executed to perform actions such as verification actions requested by the government agency may be created by the government agency. For example, the government agency may decide that additional information may be desired in the future to generate the title. The government agency may create a smart contract on the vehicle management system to add the additional information to the NFT-VID of the vehicle and/or an NFT-DID of the buyer and/or seller, and to include the additional information in the request for the title and/or title information. The smart contract may be executed automatically when the request is generated by the contract executing VM, or the smart contract may be executed in response to a request sent by the government agency to the vehicle management system.

Referring now to FIG. 4A, a first portion of an exemplary method 400 is shown for managing a sale of a vehicle of a vehicle management system, such as vehicle management system 102 of FIG. 1, including managing various transactions involved in the sale. Method 400 may be executed by a processor of the vehicle management system, (e.g., processor 106), based on instructions stored in a memory (e.g., memory 104) of the vehicle management system. For example, the instructions may be stored in one or more of an NFT-VID management module (e.g. NFT-VID management module 112) memory, and an NFT-DID management module (e.g. NFT-DID management module 114) of the memory. Additionally or alternatively, some of the steps of method 400 may be executed by a contracting executing VM embedded in a blockchain of the vehicle management system, or a copy of the blockchain in a computing device of an owner of the vehicle, or another party linked to the vehicle.

Method 400 begins at 402, where method 400 includes receiving a vehicle purchase request regarding a selected vehicle of the vehicle management system, the purchase request including one or more conditions of purchase from a prospective buyer of the vehicle. In various embodiments, the purchase request, vehicle selection, and buyer conditions may be received via a GUI of a web application or website of the vehicle management system.

At 404, method 400 includes determining whether the buyer is registered with the vehicle management system, where the buyer has an NFT-DID stored on the blockchain of the vehicle management system. If at 404 it is determined that the buyer is not registered with the vehicle management system, method 400 proceeds to 406.

At 406, method 400 includes prompting the buyer to generate an NFT-DID on the vehicle management system. Prompting the buyer to generate the NFT-DID may include prompting the buyer to download and install a vehicle management system application (e.g., VMS application 136) on a computing device (e.g., computing device 132). In various embodiments, downloading and installing the VMS application may include installing a copy of the blockchain of the vehicle management system on the computing device (e.g., blockchain 140). Downloading and installing the VMS application may also include installing a streaming service on the computing device (e.g., streaming service 138), which may stream real-time event data to the copy of the blockchain at the computing device and/or the (original, master copy of the) blockchain installed in the vehicle management system. As described in more detail below, one or more smart contracts written to the NFT-DID stored on the blockchain or copy of the blockchain in the executed based on the real-time event data received by the contract executing VM of the block chain or of the copy of the block chain. Method 400 then proceeds to 408.

If at 404 it is determined that the buyer is registered with the vehicle management system, method 400 proceeds to 408. At 408, method 400 includes notifying the contract executing VM in the copy of the blockchain installed at the seller's computing device of the purchase request, including the buyer's data, via the streaming service. In other words, when the vehicle management system (VMS) receives the request, the VMS may pass data of the request to the streaming service of the VMS (e.g., streaming service 110). The streaming service may broadcast the data of the request to one or more contract executing VMs in various computing devices held by users of the vehicle management system, including the contract executing VM in the copy of the blockchain installed at the seller's computing device. When the contract executing VM at the seller's computing device receives the request data, the contract executing VM may retrieve the NFT-DID of the seller from the copy of the blockchain, based on a seller ID of the request data. For example, the contract executing VM may send a request for the NFT-DID to an NFT-DID management module of the VMS (e.g., NFT-DID management module 114), and the NFT-DID management module may retrieve the NFT-DID from the blockchain. The contract executing VM may retrieve, from the NFT-DID of the seller, one or more smart contracts written by the seller (e.g., establishing seller conditions of sale). The contract executing VM may execute the one or more smart contracts based on the data in the purchase request. The one or more smart contracts may determine whether the conditions of the seller are satisfied. In some cases, determining whether the conditions of the seller are satisfied may include retrieving data of the buyer from an NFT-DID of the buyer, which may be retrieved from the blockchain as described above.

For example, a condition of the seller may be that the buyer purchase the vehicle in cash. The purchase request may include an ID of the buyer. When the contract executing VM embedded in the blockchain of the seller receives the ID of the buyer, the contract executing VM may request that the NFT-DID management module retrieve the NFT-DID of the buyer based on the ID. The contract executing VM may consult an amount of money in a digital wallet of the buyer (e.g., in digital wallet field 256) to determine whether sufficient funds are available to purchase the vehicle. If sufficient funds are available, the condition of the seller may be satisfied, and the sale may be permitted. If sufficient funds are not available, the condition of the seller may not be satisfied, and the sale may be cancelled.

At 410, method 400 includes determining whether one or more conditions of the seller for selling the vehicle imposed by one or more smart contracts of the seller (e.g., owner smart contracts 262 of an NFT-DID of the seller) have been satisfied. If at 410 it is determined that the one or more conditions of the seller for selling the vehicle have not been satisfied, method 400 proceeds to 412. At 412, method 400 includes notifying the seller and/or the buyer of any corrective actions that may be performed to satisfy the one or more seller conditions, and method 400 proceeds back to 408.

Alternatively, if at 410 it is determined that the conditions of the seller for selling the vehicle imposed by the one or more smart contracts of the seller have been satisfied, method 400 proceeds to 414. At 414, method 400 includes sending a request to sell the vehicle to the buyer, on behalf of the seller.

Method 400 is continued in FIG. 4B for the sake of clarity, where additional steps of method 400 are described.

Referring now to FIG. 4B, a second portion 440 of method 400 continues where the first portion of FIG. 4A left off. Second portion 440 starts at 442, where method 400 includes notifying the contract executing VM in the copy of the blockchain installed at the buyer's computing device of the vehicle sale request from the seller, via the streaming service. In other words, as a result of the seller's conditions of sale being determined satisfied by the contract executing VM at the seller's computing device, the contract executing VM at the seller's computing device may generate the sale request, and stream the sale request to the buyer's computing device via the streaming service. The sale request may be received at the buyer's computing device.

At 444, method 400 includes determining whether one or more conditions of the buyer for buying the vehicle imposed by one or more smart contracts of the buyer have been satisfied. For example, a condition of the buyer may be that the buyer may offer to purchase the vehicle if the vehicle is brought to a location of the seller. In various embodiments, the one or more smart contracts of the buyer may be stored in the NFT-DID of the seller (or of the buyer), under buyer smart contracts 274 of vehicles of interest 270. If at 444 it is determined that the one or more conditions of the buyer have not been satisfied, method 400 proceeds to 446. At 446, method 400 includes notifying the seller and/or the buyer of any corrective actions that may be performed to satisfy the one or more buyer conditions, and method 400 proceeds back to 442.

Alternatively, if at 444 it is determined that the conditions of the buyer for buying the vehicle imposed by the one or more smart contracts of the buyer have been satisfied, method 400 proceeds to 448. At 448, method 400 includes prompting the buyer and the seller to confirm that the conditions for purchasing the vehicle imposed by both the buyer and the seller have been met. In various embodiments, the buyer may be prompted for confirmation of sale via a GUI of the VMS application installed on the computing device of the buyer, and the seller may be prompted for confirmation of sale via a GUI of the VMS application installed on the computing device of the seller.

At 450, method 400 includes determining whether the sale has been confirmed by the buyer and the seller. Confirmation of the sale may be carried out by a smart contract. For example, the buyer may confirm the sale via the buyer's VMS application. When the buyer confirms the sale, the buyer's VMS application may notify the buyer's streaming service installed in the buyer's computing device (e.g., streaming service 138). The buyer's streaming service may stream the confirmation of sale, whereby the confirmation of sale may be received at the contract executing VM embedded in the blockchain of the seller's computing device The seller may confirm the sale via the seller's VMS application running on the seller's computing device. When the seller confirms the sale, the seller's VMS application may notify the seller's streaming service installed in the seller's computing device (e.g., streaming service 138). The seller's streaming service may stream the confirmation of sale, whereby the confirmation of sale may be received at the contract executing VM embedded in the blockchain of the vehicle management system (e.g., contract executing VM 109 of blockchain 108). The confirmation of sale may be similarly received at the contract executing VM from the buyer.

The contract executing VM embedded in the blockchain of the vehicle management system may submit a first confirmation of sale from the seller and a second confirmation of sale from the buyer to a smart contract stored, for example, in an NFT-VID of the vehicle (e.g., generic smart contracts 234). For example, the smart contract for confirming the sale may be automatically generated and stored in the NFT-VID when the NFT-VID is created. In some embodiments, additionally or alternatively, the smart contract for confirming the sale may be automatically generated and stored in an NFT-DID of the buyer and/or the seller when the NFT-DIDs are created (e.g., generic smart contracts 276).

If it is determined at 450 that the sale is not confirmed (e.g., the conditions of the buyer and/or the seller are not met), method 400 proceeds to 452. At 452, method 400 includes aborting the sale transaction. In various embodiments, when the sale transaction is aborted, notifications may be sent to the buyer and the seller indicating, for example, whether the buyer did not confirm the sale, or the seller did not confirm the sale.

Alternatively, if it is determined at 450 that the sale is confirmed (e.g., the conditions of the buyer and the seller are met), method 400 proceeds to 454. At 454, method 400 includes automatically completing the purchase transaction. The purchase transaction may be automatically completed by the same (e.g., first) smart contract that confirms the sale, or a second, different smart contract may be executed by the first smart contract that automatically completes the purchase transaction. Completing the purchase transaction may involve various steps, which are described in greater detail below in reference to FIG. 5.

At 456, after the sale transaction have been completed, method 400 includes updating any remaining data associated with the vehicle, the buyer, and the seller in the associated NFTs on relevant copies of the blockchain, and updating the copies of the blockchain stored on the computing devices of all blockchain-holding participants in the sale transactions, which may include the buyer, the seller, an insurance agent, a regulatory authority, a government agency, a lending institution and so on. Method 400 ends.

Referring now to FIG. 5, an exemplary method 500 is shown for automatically completing one or more transactions involved in a sale of a vehicle from a seller to a buyer, where the sale is managed via a vehicle management system, such as vehicle management system 102 of FIG. 1. Method 500 may be executed by contract executing VM embedded in a blockchain of the vehicle management system, (e.g., contract executing VM 109 of blockchain 108), based on instructions provided in one or more smart contracts stored in the blockchain. In various embodiments, the one or more smart contracts are stored in an NFT-VID of the vehicle. The smart contracts may additionally or alternatively be stored in an NFT-DID of the buyer or an NFT-DID of the seller, or an NFT-DID of a different entity linked to the vehicle. Additionally, some or all of the steps of method 500 may be executed by a contracting executing VM embedded in a copy of the blockchain stored in a computing device of the seller or buyer of the vehicle, or another party linked to the vehicle (e.g., computing device 132). In some embodiments, one or more of the steps of method 500 may be performed by a first contract executing VM of a first copy of the blockchain, one or more of the steps of method 500 may be performed by a second contract executing VM of a second copy of the blockchain, and so on. In various embodiments, method 500 may be executed as part of method 4B described above.

In some embodiments, the smart contracts referred to in method 500 and other methods disclosed herein may be organized in a hierarchical manner in the NFT-VID of the vehicle, the NFT-DID of the seller, and/or the NFT-DID of the buyer. In other words, a plurality of smart contracts may execute in a cascading fashion, where a first smart contract may execute a second smart contract based on a first set of conditions; the second smart contract may execute a third smart contract based on a second set of conditions, the third smart contract may execute a fourth smart contract based on a third set of conditions, and so on. When the fourth smart contract executes, a result of the fourth smart contract may be passed back to the third smart contract. When the third smart contract executes, a result of the third smart contract may be passed back to the second smart contract, and so on. In other embodiments, the smart contracts may not be organized in a hierarchical or cascading manner, and maybe executed separately in a linear fashion. In some embodiments, the contract executing VM may execute a plurality of smart contracts in parallel.

It should be appreciated that any of the steps of method 500 may include various communications and/or transactions between participants in the sale.

Method 500 begins at 502, where, to initiate the sale of the vehicle, method 500 includes paying the seller for the vehicle. In various embodiments, the payment for the vehicle may be paid from a first digital wallet (e.g., digital wallet 256) of an NFT-DID of the buyer holding funds of the buyer, to a second digital wallet of an NFT-DID of the seller. The payment transaction may be performed automatically based on instructions written in a first smart contract executed by the contract executing VM. Upon transferring the payment, a notification may be automatically sent to the buyer and/or the seller.

In some situations, the payment, or one or more additional payments, may be made to lending institution (e.g., lending institution 156) of the buyer. For example, the buyer may purchase the vehicle with financing from the lending institution, where the buyer may pay the lending institution a down payment and agree to pay monthly payments to the lending institution until the vehicle is paid off. In such cases, the lending institution may register with the vehicle management system, as described above, whereby an NFT-DID may be created for the lending institution based on identifying information of the lending institution, and stored in the blockchain. When the NFT-DID is created, the lending institution may establish a third digital wallet for the lending institution in the NFT-DID. In accordance with a second smart contract executed by the contract executing VM, the amount of the down payment may be transferred from the first digital wallet of the buyer to the third digital wallet of the lending institution. A total amount of the purchase of the vehicle may subsequently be transferred from the third digital wallet of the lending institution to the second digital wallet of the seller. In embodiments where a lending institution is involved in the sale of the vehicle, the second smart contract may include instructions to insert data of the lending institution into a financing data field (e.g. financing data field 216) of the NFT-VID of the vehicle.

In some embodiments, a plurality of payments (e.g., monthly payments) may be scheduled to be paid from the buyer to the lending institution over time. For example, the buyer and/or the lending institution may create a smart contract for performing an agreed-upon monthly payment at a specific day of each month. The smart contract may be stored in the buyer's NFT-DID, and executed automatically on the specific day, which may be notified to a relevant contract-executing VM via one or more streaming services, as described above.

At 504, method 500 includes transferring title ownership from the seller to the buyer. Transferring the title ownership may be performed by a third smart contract executed by the contract executing VM. In some embodiments, the third smart contract may be executed based on a result of the execution of the first or second smart contracts. For example, the third smart contract may be executed as a result of or in response to the funds being transferred from the buyer's digital wallet to the seller's digital wallet. Transferring the title ownership may include requesting a title transfer from a government agency (e.g., government agency 162). For example, the third smart contract may provide instructions to send a written request to the government agency, where the written request includes identifying information of the vehicle, the buyer, and the seller, and confirmation of a sale of the vehicle from the seller to the buyer. In some embodiments, the request may be sent by the vehicle management system based on the instructions provided by the third smart contract. In other embodiments, the request may be sent by the contract executing VM. The instructions provided by the third smart contract may also include instructions to make a payment of any fees to the government agency for carrying out the title transfer, which may be transferred from the digital wallet of the government agency. In various embodiments, the government agency may register an NFT-DID of the government agency with the vehicle management system, where the fees may be transferred from the digital wallet of the buyer to a digital wallet of government agency. In other embodiments, the instructions may specify that the fees be extracted from the digital wallet of the buyer, and that the fees be sent to the government agency in a different manner.

After performing the title transfer, the government agency may send a notification of the title transfer back to the vehicle management system and/or the contract executing VM. For example, in embodiments where the government agency has an NFT-DID with the vehicle management system, the government agency may notify a streaming service installed by the vehicle management system in a computing device of the government agency (e.g., streaming service 138). The streaming service may stream the notification, which may be received by the contract executing VM. Alternatively, the government agency may notify the vehicle management system, and the vehicle management system may notify a streaming service of the vehicle management system (e.g., streaming service 110). The streaming service may stream the notification, which may be received by the contract executing VM. When the contract executing VM receives the notification, a fourth smart contract may be executed. The fourth smart contract may update the title status field (e.g., title status field 206) of the NFT-VID of the vehicle. The fourth smart contract may update an owned vehicles field (e.g., owned vehicles to 58) of the NFT-DID of the buyer to include the vehicle, and may update the owned vehicles field of the NFT-DID of the seller to remove the vehicle. The fourth smart contract may additionally notify the buyer and the seller of the successful transfer of title from the seller to the buyer.

At 506, method 500 includes submitting a request to a regulatory authority (e.g., regulatory authority 160) to register a license plate of the vehicle. In various embodiments, fees associated with registration of the vehicle by the regulatory authority may be paid for out of the buyer's digital wallet. After registering the license plate of the vehicle, the regulatory authority may send a confirmation back to the vehicle management system, which may be received by the contract executing VM as described above. In response to receiving the confirmation, the contract executing VM may execute a fifth smart contract, where the fifth smart contract may update a registration status field (e.g., registration status field 208) of the NFT-VID of the vehicle.

At 508, method 500 includes notifying an insurance agency of the seller used to insure the vehicle that the title of the vehicle has been transferred from the seller to the buyer, whereby the seller's insurance may be canceled. When a confirmation of the cancellation of the seller's insurance is sent back to the contract executing VM, a sixth smart contract may be executed that removes the seller's insurance data from the NFT-VID of the vehicle (e.g., in the insurance data field 210). A seventh smart contract may be executed based on the confirmation, which may add or update the insurance data in the NFT-VID of the vehicle. Adding or updating the insurance data in the NFT-VID of the vehicle is described in greater detail below in reference to FIG. 6.

At 510, method 500 includes disassociating the seller's data, smart contracts, digital keys, and/or other seller data from modifiable fields of the NFT-VID of the vehicle. Similarly, at 512, method 500 includes disassociating the seller's data, smart contracts, digital keys, and/or other seller data from modifiable fields of the seller's NFT-DID.

At 514, method 500 includes generating a default digital key for the buyer, and saving the default digital key in the NFT-VID of the vehicle (e.g., in assigned digital keys 218) and/or in the NFT-DID of the buyer (e.g., in assigned digital keys 264). The default digital key for the buyer may, for example, allow the buyer to access the vehicle and all functionalities of the vehicle. The digital key may be transferred to a physical key (e.g., an electronic key fob) to be given to the buyer with the vehicle. Additionally or alternatively, the digital key may be transferred to an electronic device of the buyer, such as a smart phone. Method 500 ends.

Referring now to FIG. 6, an exemplary method 600 is shown for updating insurance information of a vehicle of a vehicle management system, such as vehicle management system 102 of FIG. 1, in an NFT-VID of the vehicle and an NFT-DID of the buyer of the vehicle. Method 600 may be executed by a processor of the vehicle management system, (e.g., processor 106), based on instructions stored in a memory (e.g., memory 104) of the vehicle management system. For example, the instructions may be stored in one or more of an NFT-VID management module (e.g. NFT-VID management module 112) memory, and an NFT-DID management module (e.g. NFT-DID management module 114) of the memory. Additionally, some of the steps of method 400 may be executed by a contract executing VM embedded in a blockchain of the vehicle management system, (e.g., contract executing VM 109 of blockchain 108), based on instructions provided in one or more smart contracts stored in the blockchain. In various embodiments, the smart contracts are stored in an NFT-VID of the vehicle. The smart contracts may additionally or alternatively be stored in an NFT-DID of the buyer or an NFT-DID of the seller, or an NFT-DID of a different entity linked to the vehicle. Additionally, some or all of the steps of method 600 may be executed by a contracting executing VM embedded in a copy of the blockchain stored in a computing device of the buyer of the vehicle or a computing device of an insurance agency, or another party linked to the vehicle (e.g., computing device 132). In various embodiments, method 600 may be executed as part of method 5 described above.

While method 600 describes updating insurance information such as a new insurance policy for the vehicle, it should be appreciated that various steps of method 600 may also apply to various other 3^{rd} parties offering services to the new owner with respect to the vehicle. For example, the new owner may wish to purchase a parking permit for the vehicle at a commercial parking lot, where data of the parking permit may be added to the NFT-VID of the vehicle and/or the NFT-DID of the owner, and regular payments may be made from the owner to the commercial parking lot via the vehicle management system. As another example, the new owner may wish to contract a security system for the vehicle that involves monthly monitoring of the vehicle by a security company.

Method 600 begins at 602, where method 400 includes receiving, at the vehicle management system, a request to associate a new insurance policy with the vehicle. In various embodiments, the request may be sent by the buyer via a GUI of an application of the vehicle management system (e.g., VMS application 136) installed on a computing device of the buyer (e.g., computing device 132). For example, the buyer may research and purchase an insurance policy with a chosen insurance agent (e.g., insurance agency 158). After purchasing the insurance policy, the buyer may open the application and enter in insurance data associated with the insurance agent and the insurance policy. The buyer may submit the request to the vehicle management system via the application.

In some embodiments, the request may be sent in response to a notification sent to the buyer prompting the buyer to add insurance information to the NFT-VID of the vehicle using the vehicle management system. The notification may be generated automatically by a smart contract. For example, the smart contract may detect that an ownership of the vehicle has changed, and that there is no insurance data associated with the vehicle, and as a result, the smart contract may send the notification. The request may also be sent to update insurance data previously stored on the NFT-VID. For example, the buyer may purchase a first insurance policy for the vehicle at a first time. The buyer may cancel the first insurance policy at a second time, and submit a request to the vehicle management system to update the insurance data in the NFT-VID.

Alternatively, the chosen insurance agent may send the request to associate the new insurance policy with the vehicle. The chosen insurance agent may send the request via a website or web application of the vehicle management system.

At 604, method 600 includes determining whether the sender of the request is registered with the vehicle management system, where the sender has an NFT-DID stored on the blockchain of the vehicle management system. In some examples, the sender is the buyer, and the buyer is registered with the vehicle management system. In other examples, the sender may be the chosen insurance agent, and the chosen insurance agent may not be registered with the vehicle management system. If at 604 it is determined that the buyer is not registered with the vehicle management system, method 600 proceeds to 606.

At 606, method 600 includes prompting the sender (e.g., the insurance agent) to register with and generate an NFT-DID on the vehicle management system. Prompting the sender to generate the NFT-DID may include prompting the sender to download and install the vehicle management system application on a computing device of the sender. In various embodiments, downloading and installing the VMS application may include installing a copy of the blockchain of the vehicle management system on the computing device (e.g., blockchain 140). Downloading and installing the VMS application may also include installing a streaming service on the computing device (e.g., streaming service 138), which may stream real-time event data to the copy of the blockchain at the computing device and/or the (original, master copy of the) blockchain installed in the vehicle management system. After the VMS application is installed, the sender may use the VMS application to interact with the vehicle management system.

If at 604 it is determined that the sender is registered with the vehicle management system (e.g., where the sender is the buyer), method 600 proceeds to 608. At 608, method 600 includes adding the new insurance data to the NFT-VID of the vehicle.

At 610, adding the new insurance data to the NFT-VID of the vehicle may include notifying the contract executing VM (e.g., of the blockchain of the vehicle management system or of the copy of the blockchain installed in the computing device of the sender) of the new insurance data. The contract executing VM may be notified by streaming the new insurance data via the streaming service. The streamed new insurance data may be received at the contract executing VM. When the new insurance data is received at the contract executing VM, the contract executing VM may apply one or more smart contracts to the new insurance data. For example, the one or more smart contracts for updating third-party data may be stored in a smart contracts field (e.g., generic smart contracts field 234) of the NFT-VID, where the smart contracts field is used for smart contracts that may be a applicable to a plurality of vehicles. In some embodiments, the one or more smart contracts may be copied into the smart contracts field of the NFT-VID when the NFT-VID is created.

At 612, adding the new insurance data to the NFT-VID of the vehicle includes determining whether one or more smart contracts executes based on the new insurance data received via the streaming service. For example, a smart contract may verify that an insurance coverage of a policy of the new insurance data is legally sufficient to insure the vehicle, or that the new insurance data is correct. An execution of the one or more smart contracts may indicate that the insurance coverage is not legally sufficient to ensure the vehicle, or that the new insurance data may not be correct, or that there is a different problem with the new insurance data.

If at 612 it is determined that one or more smart contracts have executed based on the new insurance data, method 600 proceeds to 614. At 614, method 600 includes notifying the sender of corrective actions to take with respect to the new insurance data, and method 600 ends. For example, the notification may indicate that a portion of the new insurance data is incorrect, or that the new insurance policy is invalid, or different problem. In response to receiving a notification, the sender may correct the new insurance data for a subsequent submission to the vehicle management system.

If at 612 it is determined that no smart contracts have executed based on the new insurance data, it may be assumed that the new insurance data is sufficient, correct, and valid, and method 600 may proceed to 616. At 616, method 600 includes updating the NFT-VID of the vehicle with the new insurance data. For example, the new insurance data may be stored in an insurance data field (e.g., insurance data field 210) of the NFT-VID. The new insurance data may replace previous insurance data, or the previous insurance data may remain in the insurance data field.

At 618, method 600 may include setting up future payments to the chosen insurance agent to be made out of a digital wallet of the buyer, as described above in reference to FIG. 5 with reference to the lending institution. To set up future payments to the chosen insurance agent, the buyer may create a smart contract that may execute when a specified date is reached. When the specified date is reached, the smart contract may transfer an established amount from the digital wallet of the buyer to a digital wallet of the insurance agent. The transfer may be carried out automatically by the contract executing VM based on the specific date being reached, and may not rely on any action taken by the buyer or the chosen insurance agent. As a result of the transfer being carried out automatically, a burden of the buyer and/or the chosen insurance agent may be reduced. Additionally, a time taken to perform the transfer may be reduced. Further, because the smart contract may execute on the computing device of the buyer or the insurance agent, and amount of memory and processing resources of the vehicle management system may be reduced, resulting in more efficient vehicle management overall.

At 620, method 600 includes updating all copies of the block chain stored at computing devices of parties links to the vehicle (e.g., the buyer, the seller, and the insurance agent), and method 600 ends.

As an example, a smart contract may be established by default when an NFT-VID of a vehicle is generated, which may specify that an insurance policy of the vehicle be valid and up-to-date for a new owner to operate the vehicle. At a first time that a new owner uses a digital key of the vehicle, the insurance policy may be valid and up-to-date. At a second, later time that the new owner uses the digital key, the insurance policy may not be valid and up-to-date. For example, the new owner may not pay the insurance premiums, and the insurance policy may be canceled.

When the new owner uses the digital key, the use of the digital key may be streamed (e.g., as a new event) by a streaming service running at the vehicle to a contract execution VM stored in a blockchain installed or stored, for example, at the vehicle management system, or at a computing device of the new owner. When the contract executing VM receives the streamed event, the contract executing VM may identify the vehicle from data included in the event. The contract executing VM may retrieve an NFT-VID corresponding to the vehicle from the blockchain. The contract executing VM may retrieve the smart contract for checking the insurance data from the NFT-VID (e.g., from generic smart contracts 234), and input the event data into the smart contract. The smart contract may determine whether the insurance policy is valid based on instructions of the smart contract, a current date, data included in the event, and/or other data associated with the vehicle or the new owner. In a first condition where the insurance policy is valid, the smart contract may not execute. As a result of the smart contract not executing, the new owner may be permitted to operate the vehicle at the first time.

At the second, later time, the insurance policy may not be valid and up-to-date (e.g., expired, canceled, etc.), and the smart contract may execute. When the smart contract executes, instructions and/or code may be generated, which the contract executing VM may send to the digital key, which may not allow the owner to operate the vehicle. Additionally or alternatively, instructions may be generated to notify the new owner and/or the insurance agent that the insurance policy is no longer valid.

Thus, methods and systems are disclosed for managing, tracking, and storing vehicle ownership data as a vehicle changes ownership over a course of the vehicle's life. The managing, tracking, and storing of the vehicle ownership data may be performed by smart contracts saved on a blockchain, where the smart contracts are automatically executed based on real-time event data transmitted from one or more streaming services to a contract executing VM embedded in the blockchain. The smart contracts may be stored in NFTs on the blockchain, where the NFTs may be associated with at least one of the vehicle, an owner of the vehicle, or a different participant in a sale of the vehicle, such as a lending institution, an insurance agent, a government agency, a regulatory authority, and so on. A master copy of the blockchain including the NFTs may be stored and installed in a vehicle management system, and copies of the blockchain may be stored and installed on various computing devices of parties linked to or associated with the vehicle.

The NFTs may include identifying information of the vehicle, one or more owners of the vehicle, one or more prospective buyers of the vehicle, and/or identifying information of the different participants in the sale of the vehicle. The NFTs may be created and/or updated via the vehicle management system. The smart contracts may be executed by a first contract executing VM embedded in the master copy of the blockchain included in the vehicle management system, or by a different contract executing VM of a copy of the blockchain installed on a computing device of a participant in the sale. By executing the smart contracts at one or more computing devices rather than the vehicle management system, a speed with which the contracts are executed may be increased, and a use of processing and memory resources by the vehicle management system may be reduced, increasing a general efficiency of the vehicle management system. Additionally, when the smart contracts are executed at a computing device of a participant, contract execution may not rely on communications to and from the vehicle management system, which may be delayed or unavailable due to network or technical issues. When the smart contracts are executed at computing devices of participants, and do not involve communicating with the vehicle management system over a network, a security of the ownership data may also be increased due to a decreased amount of communication over the network. As a result, contract execution at the computing devices may lead to a more robust and reliable management of vehicle ownership data.

In general, performing transactions involved in a change of ownership of a vehicle by smart contracts stored on a blockchain rather than by centralized code of the vehicle management system may allow greater flexibility in terms of supporting a wide and scalable set of permitted actions and transactions. An owner may have freedom to write their own smart contracts (e.g., via a wizard of a GUI of the vehicle management system) with varying levels of complexity, which may be executed automatically based on conditions imposed by the owner. In contrast, supporting a wide variety of possible transactions that may be performed during a change of ownership of a vehicle with operational code of the vehicle management system may be costly, and an expansion of permitted transactions may be slow due to limited available developer time. By leveraging the flexibility of smart contracts, an amount of resources consumed by the vehicle management system may be reduced, and an overall efficiency of maintaining the vehicle management system may be increased. Additionally, because the blockchain operates as a distributed ledger where various copies of the blockchain may exist at different computing devices held by different users of the vehicle management system (e.g., participants in the distributed ledger), a validity of the vehicle, owner, and other user data stored in NFTs of the blockchain may be ensured, and a security of the smart contracts may be increased. When presented with a possibility that data stored on the blockchain (such as a smart contract) may have been altered by an unauthorized person, copies of the blockchain may be quickly compared, using various methods known in the art, to determine whether data of one or more copies of the blockchain are inconsistent with other copies of the blockchain, and therefore invalid.

The technical effect of managing, tracking, and storing vehicle ownership data using smart contracts on a blockchain maintained by a vehicle management system, is that a validity of the smart contracts may be ensured, an efficiency of the vehicle management system may be increased, and a flexibility with which different transactions involved in a change of ownership of the vehicle may be supported may be increased.

The disclosure also provides support for a decentralized, distributed vehicle management system, comprising: a blockchain, a streaming service configured to provide event data in real time to a contract executing virtual machine (VM) embedded in the blockchain, and a non-transitory memory storing instructions that when executed by a processor of the vehicle management system, cause the vehicle management system to: manage ownership data of a vehicle of the vehicle management system, including changes in ownership of the vehicle, via smart contracts that execute automatically in response to real-time event data streamed by the streaming service, wherein the smart contracts are created by various users of the vehicle management system linked to or associated with the vehicle, and wherein the smart contracts are executed at at least one of the contract executing VM of the blockchain and a contract executing VM of a copy of the blockchain installed on a computing device of a user of the various users. In a first example of the system, the various users of the vehicle management system linked to or associated with the vehicle include two or more of: a seller of the vehicle, a buyer of the vehicle, a lending institution providing financing for the vehicle, an insurance agency providing an insurance policy for the vehicle, a regulatory authority that regulates an operation of the vehicle, and a government agency that issues a title of the vehicle. In a second example of the system, optionally including the first example, the smart contracts are stored in a non-fungible token (NFT) of the vehicle and/or one or more NFTs of users of the vehicle management system, the NFTs stored in various copies of the blockchain, each copy of the blockchain stored in a computing device of a user of the vehicle management system, and wherein the smart contracts are executed by one or more contract executing VMs embedded in the various copies of the blockchain, and not executed in the blockchain stored at the vehicle management system. In a third example of the system, optionally including one or both of the first and second examples, the smart contracts are configured to perform a plurality of interactions and/or transactions between the users of the vehicle management system relating to a sale of the vehicle from the seller to the buyer, without relying on communicating with the vehicle management. In a fourth example of the system, optionally including one or more or each of the first through third examples, the plurality of interactions and/or transactions between the users of the vehicle management system relating to a sale of the vehicle include one or more of: transferring funds of the buyer to the seller to pay a purchase price of the vehicle, the funds transferred from a first digital wallet stored in an NFT of the buyer to a second digital wallet stored in an NFT of the seller, requesting and receiving updated title data from a government agency, and storing the updated title data in the NFT of the vehicle, registering a license plate of the vehicle with a regulatory authority, and storing registration data received from the regulatory authority in the NFT of the vehicle, cancelling an insurance policy of the seller with an insurance agent, and removing insurance data of the seller from the NFT of the vehicle, disassociating one or more digital keys of the seller to the vehicle with the vehicle in the NFT of the vehicle, disassociating one or more smart contracts of the seller regarding the vehicle in the NFT of the seller and/or the NFT of the vehicle, and generating a digital key for the buyer, storing the digital key in the NFT of the buyer and/or the NFT of the vehicle, and sending the digital key to the buyer.

The disclosure also provides support for a method for a blockchain-based vehicle management system, the method comprising: receiving, at a computing device of a seller of a vehicle of the vehicle management system, a request to purchase a vehicle sent from a computing device of a buyer, the request including identifying information of the buyer and the vehicle, the computing device of the seller including a first copy of a master copy of a blockchain of the vehicle management system and the computing device of the buyer including a second copy of the master copy of the blockchain, and in response to receiving the request: retrieve data of an owner and seller of the vehicle from the first copy of the blockchain based on the identifying information of the vehicle, the data including a first smart contract written by the owner, the first smart contract including one or more conditions of the seller for selling the vehicle, retrieve data of the buyer from the first copy of the blockchain based on the identifying information of the buyer, the data including a second smart contract written by the buyer, the second smart contract including one or more conditions of the buyer for purchasing the vehicle, execute the first smart contract based on the data of the buyer to determine whether the one or more conditions of the seller have been met, in response to a result of executing the first smart contract indicating that the one or more conditions of the seller have been met, execute the second smart contract based on the data of the buyer to determine whether the one or more conditions of the buyer have been met, in response to a result of executing the second smart contract indicating that the one or more conditions of the buyer have been met, execute a third smart contract, the third smart contract requesting a confirmation of a sale from both of the buyer and the seller, in response to a result of executing the third smart contract indicating that the sale is confirmed by both the buyer and the seller, execute a fourth smart contract, the fourth smart contract performing one or more transactions to conclude the sale of the vehicle, executing a fifth smart contract to store new ownership data of the buyer, the seller, and the vehicle in a copy of the blockchain, updating one or more copies of the blockchain installed on one or more computing devices of participating parties in the sale of the vehicle, the one or more copies including the master copy, the first copy of the blockchain, and the second copy of the blockchain. In a first example of the method, one or more of the first smart contract, the second smart contract, the third smart contract, the fourth smart contract, and the fifth smart contract are executed by different contract executing virtual machines (VM) embedded in either the master copy of the blockchain installed at the vehicle management system, and/or different copies of the blockchain installed in the one or more computing devices of participating parties in the sale of the vehicle. In a second example of the method, optionally including the first example, none of the first smart contract, the second smart contract, the third smart contract, the fourth smart contract, and the fifth smart contract are executed by a contract executing VM embedded in the master copy of the blockchain installed at the vehicle management system. In a third example of the method, optionally including one or both of the first and second examples, the method further comprises: in response to either of the result of executing the first smart contract indicating that the one or more conditions of the seller have not been met and the result of executing the second smart contract indicating that the one or more conditions of the buyer have not been met, sending a notification to at least one of the buyer and the seller, the notification including one or more corrective actions to take to conclude the sale of the vehicle. In a fourth example of the method, optionally including one or more or each of the first through third examples, storing the new ownership data of the buyer, the seller, and the vehicle in the copy of the blockchain further comprises: writing the data of the vehicle to a non-fungible token (NFT) of the vehicle stored in the copy of the blockchain, writing the data of the buyer to the NFT of the buyer stored in the copy of the blockchain, and removing data of the seller from the NFT of the seller stored in the copy of the blockchain. In a fifth example of the method, optionally including one or more or each of the first through fourth examples, the NFT of the vehicle includes at least one of: identifying information of the vehicle, title data of the vehicle, registration data of the vehicle, insurance data of the vehicle, financing data of the vehicle, information on assigned digital keys to the vehicle, identifying information of one or more owners of the vehicle, identifying information of one or more purchase requests of the vehicle, and one or more generic smart contracts for processing information of the vehicle. In a sixth example of the method, optionally including one or more or each of the first through fifth examples, the NFT of the seller includes at least one of: identifying information of the seller, a digital wallet of the seller, information of a vehicle owned by the owner, including identifying information of the vehicle, digital keys assigned to the vehicle, and one or more smart contracts of the owner relating to the vehicle, the one or more smart contracts including the conditions of the seller for selling the vehicle, and one or more generic smart contracts for processing information of the vehicle. In a seventh example of the method, optionally including one or more or each of the first through sixth examples, the NFT of the buyer includes at least one of: identifying information of the buyer, a digital wallet of the buyer, one or more generic smart contracts for processing information of the vehicle, and information of a vehicle the buyer is interested in purchasing, the information including one or more smart contracts of the buyer, the one or more smart contracts including the conditions of the buyer for purchasing the vehicle.

The disclosure also provides support for a method for managing ownership data of a vehicle by a vehicle management system, the method comprising: creating a first non-fungible token (NFT) for the vehicle including data of the vehicle, and storing the first NFT on a blockchain of the vehicle management system, the first NFT including first set of one or more smart contracts for initiating and conducting a sale of the vehicle to a buyer, creating a second NFT for an owner of the vehicle including data of the owner, and storing the second NFT on the blockchain, the second NFT including a second set of one or more smart contracts created by the owner/seller, and establishing conditions of the owner for selling the vehicle, creating a third NFT for a prospective buyer of the vehicle including data of the buyer, and storing the third NFT on the blockchain, the third NFT including a third set of one or more smart contracts created by the buyer and establishing conditions of the buyer for purchasing the vehicle, receiving event data relating to the first, second, and/or third sets of one or more smart contracts at one or more contract executing virtual machines (VM) embedded in one or more copies of the blockchain installed on one or more computing devices in wireless communication with the vehicle management system, the one or more contract executing VMs configured to execute the first, second, and/or third sets of one or more smart contracts based on the event data, and in response to a smart contract of the first set of one or more smart contracts being executed by the one or more contract executing VMs, perform one or more transactions for changing ownership of the vehicle from the seller to the buyer. In a first example of the method, the smart contract of the first set of one or more smart contracts is executed by the one or more contract executing VMs based on data included in a request to purchase the vehicle sent from the buyer to the seller, the data streamed to the one or more contract executing VMs by a streaming service installed in at least one of the vehicle management system and one or more computing devices of participating parties in the sale of the vehicle, the participating parties including the buyer and the seller. In a second example of the method, optionally including the first example, the first, second, and/or third sets of one or more smart contracts are executed by different versions of the one or more contract executing VMs embedded in different copies of the blockchain installed at the vehicle management system or the one or more computing devices of participating parties in the sale of the vehicle. In a third example of the method, optionally including one or both of the first and second examples, the first, second, and/or third sets of one or more smart contracts are executed by versions of the one or more contract executing VMs embedded in copies of the blockchain installed at the one or more computing devices and not at the vehicle management system. In a fourth example of the method, optionally including one or more or each of the first through third examples, performing the one or more transactions included in selling the vehicle from the seller to the buyer further comprises at least one of: transferring funds of the buyer to the seller to pay a purchase price of the vehicle, the funds transferred from a first digital wallet stored in the third NFT of the buyer to a second digital wallet stored in the second NFT of the seller, requesting and receiving updated title data from a government agency, and storing the updated title data in the first NFT of the vehicle, registering a license plate of the vehicle with a regulatory authority, and storing registration data received from the regulatory authority in the first NFT of the vehicle, cancelling an insurance policy of the seller with an insurance agent, and removing insurance data of the seller from the first NFT of the vehicle, removing one or more digital keys of the seller to the vehicle in the first NFT of the vehicle and/or the second NFT of the seller, disassociating one or more smart contracts of the seller regarding the vehicle in the second NFT of the seller and/or the first NFT of the vehicle, and generating a digital key for the buyer, storing the digital key in the third NFT of the buyer and/or the first NFT of the vehicle, and sending the digital key to the buyer. In a fifth example of the method, optionally including one or more or each of the first through fourth examples, performing the one or more transactions for changing ownership of the vehicle from the seller to the buyer further comprises: in response to receiving a request to associate new data with the vehicle in the vehicle management system: generating an NFT for a sender of the request, on a copy of the blockchain installed on a computing device of the sender, via an application of the vehicle management system installed by the sender on the computing device, stream the new data using a streaming service installed on the computing device, via the application, receive the new data at a contract executing VM embedded in the copy of the blockchain installed on the computing device of the sender, in response to one of the one or more smart contracts for associating the new data with the vehicle not executing or executing with a result indicating that the new data may be associated with the vehicle, adding the new data to at least the NFT of the vehicle. In a sixth example of the method, optionally including one or more or each of the first through fifth examples, the sender is an insurance agency, and the new data is a new insurance policy of the vehicle.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for case of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first.” “second.” “third.” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A decentralized, distributed vehicle management system, comprising:
a blockchain;
a streaming service configured to provide event data in real time to a contract executing virtual machine (VM) embedded in the blockchain; and
a non-transitory memory storing instructions that when executed by a processor of the vehicle management system, cause the vehicle management system to:
manage ownership data of a vehicle of the vehicle management system, including changes in ownership of the vehicle, via smart contracts that execute automatically in response to real-time event data streamed by the streaming service, wherein the smart contracts are created by various users of the vehicle management system linked to or associated with the vehicle, and wherein the smart contracts are executed at at least one of the contract executing VM of the blockchain and a contract executing VM of a copy of the blockchain installed on a computing device of a user of the various users.

2. The vehicle management system of claim 1, wherein the various users of the vehicle management system linked to or associated with the vehicle include two or more of:
a seller of the vehicle;
a buyer of the vehicle;
a lending institution providing financing for the vehicle;
an insurance agency providing an insurance policy for the vehicle;
a regulatory authority that regulates an operation of the vehicle; and
a government agency that issues a title of the vehicle.

3. The vehicle management system of claim 1, wherein:
the smart contracts are stored in a non-fungible token (NFT) of the vehicle and/or one or more NFTs of users of the vehicle management system, the NFTs stored in various copies of the blockchain, each copy of the blockchain stored in a computing device of a user of the vehicle management system; and
wherein the smart contracts are executed by one or more contract executing VMs embedded in the various copies of the blockchain, and not executed in the blockchain stored at the vehicle management system.

4. The vehicle management system of claim 2, wherein the smart contracts are configured to perform a plurality of interactions and/or transactions between the users of the vehicle management system relating to a sale of the vehicle from the seller to the buyer, without relying on communicating with the vehicle management.

5. The vehicle management system of claim 4, wherein the plurality of interactions and/or transactions between the users of the vehicle management system relating to a sale of the vehicle include one or more of:
transferring funds of the buyer to the seller to pay a purchase price of the vehicle, the funds transferred from a first digital wallet stored in an NFT of the buyer to a second digital wallet stored in an NFT of the seller;
requesting and receiving updated title data from a government agency, and storing the updated title data in the NFT of the vehicle;
registering a license plate of the vehicle with a regulatory authority, and storing registration data received from the regulatory authority in the NFT of the vehicle;
cancelling an insurance policy of the seller with an insurance agent, and removing insurance data of the seller from the NFT of the vehicle;
disassociating one or more digital keys of the seller to the vehicle with the vehicle in the NFT of the vehicle;
disassociating one or more smart contracts of the seller regarding the vehicle in the NFT of the seller and/or the NFT of the vehicle; and
generating a digital key for the buyer, storing the digital key in the NFT of the buyer and/or the NFT of the vehicle, and sending the digital key to the buyer.

6. A method for a blockchain-based vehicle management system, the method comprising:
receiving, at a computing device of a seller of a vehicle of the vehicle management system, a request to purchase a vehicle sent from a computing device of a buyer, the request including identifying information of the buyer and the vehicle; the computing device of the seller including a first copy of a master copy of a blockchain of the vehicle management system and the computing device of the buyer including a second copy of the master copy of the blockchain; and
in response to receiving the request:
retrieve data of an owner and seller of the vehicle from the first copy of the blockchain based on the identifying information of the vehicle, the data including a first smart contract written by the owner, the first smart contract including one or more conditions of the seller for selling the vehicle;
retrieve data of the buyer from the first copy of the blockchain based on the identifying information of the buyer, the data including a second smart contract written by the buyer, the second smart contract including one or more conditions of the buyer for purchasing the vehicle;
execute the first smart contract based on the data of the buyer to determine whether the one or more conditions of the seller have been met;
in response to a result of executing the first smart contract indicating that the one or more conditions of the seller have been met, execute the second smart contract based on the data of the buyer to determine whether the one or more conditions of the buyer have been met;
in response to a result of executing the second smart contract indicating that the one or more conditions of the buyer have been met, execute a third smart contract, the third smart contract requesting a confirmation of a sale from both of the buyer and the seller;
in response to a result of executing the third smart contract indicating that the sale is confirmed by both the buyer and the seller, execute a fourth smart contract, the fourth smart contract performing one or more transactions to conclude the sale of the vehicle;
executing a fifth smart contract to store new ownership data of the buyer, the seller, and the vehicle in a copy of the blockchain;
updating one or more copies of the blockchain installed on one or more computing devices of participating parties in the sale of the vehicle, the one or more copies including the master copy, the first copy of the blockchain, and the second copy of the blockchain.

7. The method of claim 6, wherein one or more of the first smart contract, the second smart contract, the third smart contract, the fourth smart contract, and the fifth smart contract are executed by different contract executing virtual machines (VM) embedded in either the master copy of the blockchain installed at the vehicle management system, and/or different copies of the blockchain installed in the one or more computing devices of participating parties in the sale of the vehicle.

8. The method of claim 7, wherein none of the first smart contract, the second smart contract, the third smart contract, the fourth smart contract, and the fifth smart contract are executed by a contract executing VM embedded in the master copy of the blockchain installed at the vehicle management system.

9. The method of claim 6, further comprising:
in response to either of the result of executing the first smart contract indicating that the one or more conditions of the seller have not been met and the result of executing the second smart contract indicating that the one or more conditions of the buyer have not been met, sending a notification to at least one of the buyer and the seller, the notification including one or more corrective actions to take to conclude the sale of the vehicle.

10. The method of claim 6, wherein storing the new ownership data of the buyer, the seller, and the vehicle in the copy of the blockchain further comprises:
writing the data of the vehicle to a non-fungible token (NFT) of the vehicle stored in the copy of the blockchain;
writing the data of the buyer to the NFT of the buyer stored in the copy of the blockchain; and
removing data of the seller from the NFT of the seller stored in the copy of the blockchain.

11. The method of claim 10, wherein the NFT of the vehicle includes at least one of:
identifying information of the vehicle;
title data of the vehicle;
registration data of the vehicle;
insurance data of the vehicle;
financing data of the vehicle;
information on assigned digital keys to the vehicle;
identifying information of one or more owners of the vehicle;
identifying information of one or more purchase requests of the vehicle; and
one or more generic smart contracts for processing information of the vehicle.

12. The method of claim 10, wherein the NFT of the seller includes at least one of:
identifying information of the seller;
a digital wallet of the seller;
information of a vehicle owned by the owner, including identifying information of the vehicle, digital keys assigned to the vehicle, and one or more smart contracts of the owner relating to the vehicle, the one or more smart contracts including the conditions of the seller for selling the vehicle; and
one or more generic smart contracts for processing information of the vehicle.

13. The method of claim 10, wherein the NFT of the buyer includes at least one of:
identifying information of the buyer;
a digital wallet of the buyer;
one or more generic smart contracts for processing information of the vehicle; and
information of a vehicle the buyer is interested in purchasing, the information including one or more smart contracts of the buyer, the one or more smart contracts including the conditions of the buyer for purchasing the vehicle.

14. A method for managing ownership data of a vehicle by a vehicle management system, the method comprising:
creating a first non-fungible token (NFT) for the vehicle including data of the vehicle, and storing the first NFT on a blockchain of the vehicle management system, the first NFT including first set of one or more smart contracts for initiating and conducting a sale of the vehicle to a buyer;
creating a second NFT for an owner of the vehicle including data of the owner, and storing the second NFT on the blockchain, the second NFT including a second set of one or more smart contracts created by the owner/seller, and establishing conditions of the owner for selling the vehicle;
creating a third NFT for a prospective buyer of the vehicle including data of the buyer, and storing the third NFT on the blockchain, the third NFT including a third set of one or more smart contracts created by the buyer and establishing conditions of the buyer for purchasing the vehicle;
receiving event data relating to the first, second, and/or third sets of one or more smart contracts at one or more contract executing virtual machines (VM) embedded in one or more copies of the blockchain installed on one or more computing devices in wireless communication with the vehicle management system, the one or more contract executing VMs configured to execute the first, second, and/or third sets of one or more smart contracts based on the event data; and
in response to a smart contract of the first set of one or more smart contracts being executed by the one or more contract executing VMs, perform one or more transactions for changing ownership of the vehicle from the seller to the buyer.

15. The method of claim 14, wherein the smart contract of the first set of one or more smart contracts is executed by the one or more contract executing VMs based on data included in a request to purchase the vehicle sent from the buyer to the seller, the data streamed to the one or more contract executing VMs by a streaming service installed in at least one of the vehicle management system and one or more computing devices of participating parties in the sale of the vehicle, the participating parties including the buyer and the seller.

16. The method of claim 14, wherein the first, second, and/or third sets of one or more smart contracts are executed by different versions of the one or more contract executing VMs embedded in different copies of the blockchain installed at the vehicle management system or the one or more computing devices of participating parties in the sale of the vehicle.

17. The method of claim 16, wherein the first, second, and/or third sets of one or more smart contracts are executed by versions of the one or more contract executing VMs embedded in copies of the blockchain installed at the one or more computing devices and not at the vehicle management system.

18. The method of claim 14, wherein performing the one or more transactions included in selling the vehicle from the seller to the buyer further comprises at least one of:
transferring funds of the buyer to the seller to pay a purchase price of the vehicle, the funds transferred from a first digital wallet stored in the third NFT of the buyer to a second digital wallet stored in the second NFT of the seller;
requesting and receiving updated title data from a government agency, and storing the updated title data in the first NFT of the vehicle;
registering a license plate of the vehicle with a regulatory authority, and storing registration data received from the regulatory authority in the first NFT of the vehicle;
cancelling an insurance policy of the seller with an insurance agent, and removing insurance data of the seller from the first NFT of the vehicle;
removing one or more digital keys of the seller to the vehicle in the first NFT of the vehicle and/or the second NFT of the seller;
disassociating one or more smart contracts of the seller regarding the vehicle in the second NFT of the seller and/or the first NFT of the vehicle; and
generating a digital key for the buyer, storing the digital key in the third NFT of the buyer and/or the first NFT of the vehicle, and sending the digital key to the buyer.

19. The method of claim 14, wherein performing the one or more transactions for changing ownership of the vehicle from the seller to the buyer further comprises:
in response to receiving a request to associate new data with the vehicle in the vehicle management system:
generating an NFT for a sender of the request, on a copy of the blockchain installed on a computing device of the sender, via an application of the vehicle management system installed by the sender on the computing device;
stream the new data using a streaming service installed on the computing device, via the application;
receive the new data at a contract executing VM embedded in the copy of the blockchain installed on the computing device of the sender;
in response to one of the one or more smart contracts for associating the new data with the vehicle not executing or executing with a result indicating that the new data may be associated with the vehicle, adding the new data to at least the NFT of the vehicle.

20. The method of claim 19, wherein the sender is an insurance agency, and the new data is a new insurance policy of the vehicle.
